(19) United States
(12) Patent Application Publication
(10) Pub. No.: US 2026/0234516 A1
(43) Pub. Date: Aug. 13, 2026

(54) ANHYDROUS SOLID UNIT DOSE COMPOSITIONS FOR PET-SAFE CLEANING AND ODOR NEUTRALIZATION

(71) Applicant: Pet Parents, LLC, Ankeny, IA (US)

(72) Inventors: Blake Anderssen, Ankeny, IA (US); Mikaela Sperling, Ankeny, IA (US); Josh King, Ankeny, IA (US)

(21) Appl. No.: 19/535,466

(22) Filed: Feb. 10, 2026

Related U.S. Application Data
(60) Provisional application No. 63/756,436, filed on Feb. 10, 2025.

(51) Int. Cl. C11D 17/06; C11D 1/28; C11D 3/00; C11D 3/04; C11D 3/12; C11D 3/20; C11D 3/22; C11D 3/386; C11D 17/00

(52) U.S. Cl. CPC C11D 17/06; C11D 1/28; C11D 3/0047; C11D 3/042; C11D 3/046; C11D 3/128; C11D 3/2013; C11D 3/2068; C11D 3/2079; C11D 3/223; C11D 3/38609; C11D 3/38627; C11D 17/0073; C11D 2111/12

(57) ABSTRACT

Various implementations include an anhydrous solid unit dose composition for cleaning in pet environments. The composition includes a surfactant system including one or more mild solid surfactants. The composition includes a pH control system including a buffering agent. The composition includes a carrier. The composition is configured to be reconstituted with water at a point of use to form a ready-to-use solution. The ready-to-use solution has a pH of about 5.0 to about 8.0. The composition is free of strong caustic alkalis, chlorine bleach, and peroxide bleach.

### BACKGROUND

Household cleaning products, personal care products, and deodorizing compositions have traditionally been formulated as liquid solutions containing high water content. These liquid formulations typically comprise water as the primary component, often exceeding 90% of the total formulation weight. The prevalence of water-based formulations has led to increased shipping costs, larger packaging requirements, and environmental concerns associated with single-use plastic containers.

Concentrated and anhydrous cleaning formulations have emerged as alternatives to traditional liquid products. These solid formulations, including tablets, powders, and granules, can be reconstituted with water by the consumer at the point of use. Such approaches reduce packaging waste and shipping weight while providing consumers with flexibility in preparing cleaning solutions.

Cleaning and care products designed for use in environments shared with companion animals present distinct formulation challenges compared to products intended for human-only applications. Dogs, cats, and other household pets may have different tolerances to pH levels, surfactant types, and volatile compounds than humans. Pet skin barriers, respiratory systems, and olfactory sensitivities can differ from those of humans, and pets may come into direct contact with treated surfaces through walking, lying, grooming, or licking behaviors.

Conventional cleaning products often rely on aggressive alkalinity, strong oxidizers, or heavy fragrance systems to achieve cleaning and deodorizing performance. These approaches may be acceptable for human use but can present concerns when products are used in areas frequented by pets or applied directly to pet-related items such as bedding, toys, or grooming surfaces.

Odor management in pet environments presents particular challenges. Pet-related odors often arise from biological sources including urine, feces, saliva, and skin secretions. These odors may contain ammonia compounds, sulfur-containing molecules, and other volatile organic compounds. Traditional approaches to odor management have included the use of fragrances to mask unpleasant smells, but such approaches do not address the underlying odor-causing compounds and may introduce additional volatile substances into the environment.

Enzymatic and biological cleaning systems have been employed in various cleaning applications to break down organic soils and odor-causing compounds. These bio-active systems can include enzymes such as proteases, amylases, and lipases, as well as postbiotics, ferments, and other bio-derived materials. Maintaining the stability and activity of such bio-active components in cleaning formulations presents formulation challenges, particularly with respect to pH compatibility, preservation system interactions, and storage conditions.

### SUMMARY

Various implementations include an anhydrous solid unit dose composition for cleaning in pet environments. The composition includes a surfactant system including one or more mild solid surfactants. The composition includes a pH control system including a buffering agent. The composition includes a carrier. The composition is configured to be reconstituted with water at a point of use to form a ready-to-use solution. The ready-to-use solution has a pH of about 5.0 to about 8.0. The composition is free of strong caustic alkalis, chlorine bleach, and peroxide bleach.

In some implementations, the one or more mild solid surfactants are selected from the group consisting of sodium cocoyl isethionate, sodium lauryl sulfoacetate, sodium cocoyl glutamate, sodium cocoamphoacetate, and combinations thereof. In some implementations, the surfactant system is present in an amount of about 0.5 wt % to about 60 wt % of the unit dose. In some implementations, the buffering agent includes a citric acid and sodium citrate buffer pair. In some implementations, the pH control system is present in an amount of about 0.1 wt % to about 15 wt % of the unit dose. In some implementations, the ready-to-use solution has a pH of about 5.5 to about 6.5. In some implementations, the ready-to-use solution has a pH of about 6.0 to about 7.0. In some implementations, the composition further includes a chelating agent selected from the group consisting of tetrasodium glutamate diacetate, sodium citrate, and combinations thereof. In some implementations, the composition further includes a preservation system including one or more of gluconolactone, sodium benzoate, potassium sorbate, phenoxyethanol, and ethylhexylglycerin. In some implementations, the composition is in the form of a powder, a granule, or a compressed tablet. In some implementations, the unit dose has a mass of about 0.2 g to about 453 g. In some implementations, the composition is configured to be reconstituted with about 30 mL to about 3,800 mL of water. In some implementations, the composition dissolves in water within about 1 minute to about 30 minutes. In some implementations, the composition is free of sodium lauryl sulfate, sodium laureth sulfate, ammonium lauryl sulfate, linear alkylbenzene sulfonates, alkylphenol ethoxylates, and nonylphenol ethoxylates. In some implementations, the composition is free of volatile organic solvents. In some implementations, the composition is free of microplastics and persistent synthetic polymers. In some implementations, the ready-to-use solution has a rehydrated stability of about 1 month to about 12 months. In some implementations, the carrier includes mannitol or sodium sulfate. In some implementations, the composition further includes a flow aid including silicon dioxide. In some implementations, the composition further includes one or more enzymes selected from the group consisting of protease, amylase, lipase, cellulase, urease, and combinations thereof.

Various other implementations include an anhydrous solid unit dose composition for odor neutralization. The composition includes a surfactant system, an odor neutralization system, and a carrier. The odor neutralization system includes one or more of an odor capture agent configured to capture volatile odor molecules, an odor binding agent configured to bind amine or sulfur odor compounds, or an adsorbent configured to adsorb ammonia-related compounds. The composition is configured to be reconstituted with water at a point of use to form a ready-to-use solution. The ready-to-use solution has a pH of about 5.0 to about 8.0. The composition is free of fragrance-based odor masking systems or includes a scent system at about 0 wt % to about 5 wt % of the unit dose, but preferably at about 0 wt % to about 1 wt % of the unit dose.

In some implementations, the odor capture agent includes β-cyclodextrin. In some implementations, the odor binding agent includes zinc ricinoleate. In some implementations, the adsorbent includes zeolite. In some implementations, the odor neutralization system is present in an amount of about 0.5 wt % to about 20 wt % of the unit dose. In some implementations, the composition further includes a bio-active system configured to break down odor-causing soils. In some implementations, the bio-active system includes one or more enzymes selected from the group consisting of protease, amylase, lipase, cellulase, urease, and combinations thereof. In some implementations, the ready-to-use solution has a pH of about 5.5 to about 6.5. In some implementations, the composition is free of strong caustic alkalis, chlorine bleach, and peroxide bleach. In some implementations, the surfactant system includes one or more mild solid surfactants selected from the group consisting of sodium cocoyl isethionate, sodium lauryl sulfoacetate, sodium cocoyl glutamate, sodium cocoamphoacetate, and combinations thereof. In some implementations, the composition further includes a pH control system including a citric acid and sodium citrate buffer pair. In some implementations, the composition is in the form of a powder, a granule, or a compressed tablet. In some implementations, the composition is configured to be reconstituted with about 30 mL to about 3,800 mL of water. In some implementations, the odor neutralization system includes β-cyclodextrin and zinc ricinoleate. In some implementations, the odor neutralization system includes β-cyclodextrin, zinc ricinoleate, and zeolite. In some implementations, the composition is free of high-terpene essential oil loads. In some implementations, the composition is free of volatile organic solvent deodorizers. In some implementations, the ready-to-use solution is configured for application to one or more of hard surfaces, fabrics, air, and litter systems.

Various other implementations include an anhydrous solid unit dose composition for pet care. The composition includes a bio-active system, a surfactant system including one or more mild solid surfactants, a pH control system including a buffering agent, and a carrier. The bio-active system includes one or more of enzymes, postbiotics, ferments, lysates, microbial derivatives, or combinations thereof. The composition is configured to be reconstituted with water at a point of use to form a ready-to-use solution. The bio-active system remains stable in the composition in a dry anhydrous form and is activated upon reconstitution with water. The ready-to-use solution has a pH of about 5.0 to about 8.0. The composition is free of oxidizing agents and denaturing agents that would impair bio-active function.

In some implementations, the bio-active system includes one or more enzymes selected from the group consisting of protease, amylase, lipase, cellulase, urease, and combinations thereof. In some implementations, the bio-active system includes one or more postbiotics selected from the group consisting of Lactobacillus ferment filtrate, Lactococcus ferment, Leuconostoc ferment, Saccharomyces ferment, Saccharomyces lysate, and combinations thereof. In some implementations, the bio-active system is present in an amount of about 0.001 wt % to about 10 wt % of the unit dose. In some implementations, the bio-active system includes an enzyme system present in an amount of about 0 wt % to about 20 wt % of the unit dose. In some implementations, the ready-to-use solution has a pH of about 6.0 to about 7.0. In some implementations, the composition is configured for application to pet skin or pet coat. In some implementations, the composition is configured for oral-adjacent pet applications. In some implementations, the one or more mild solid surfactants are selected from the group consisting of sodium cocoyl isethionate, sodium lauryl sulfoacetate, sodium cocoyl glutamate, sodium cocoamphoacetate, and combinations thereof. In some implementations, the buffering agent includes a citric acid and sodium citrate buffer pair. In some implementations, the composition further includes a skin comfort system including one or more of betaine, panthenol, allantoin, aloe powder, sodium PCA, colloidal oatmeal, or combinations thereof. In some implementations, the composition is in the form of a powder, a granule, or a compressed tablet. In some implementations, the ready-to-use solution has a rehydrated stability of about 1 month to about 12 months. In some implementations, the composition is free of strong caustic alkalis, chlorine bleach, peroxide bleach, and isothiazolinones. In some implementations, the composition is free of PEG/PPG film-formers, polyquaterniums, and acrylic thickeners. In some implementations, the composition further includes an odor neutralization system including one or more of β-cyclodextrin, zinc ricinoleate, zeolite, or combinations thereof. In some implementations, the composition is free of fragrance-based odor masking systems or includes a scent system at about 0 wt % to about 1 wt % of the unit dose. In some implementations, the composition further includes a preservation system including one or more of gluconolactone, sodium benzoate, potassium sorbate, phenoxyethanol, and ethylhexylglycerin. In some implementations, the preservation system is compatible with the bio-active system at the pH of the ready-to-use solution.

Various other implementations include a method of preparing a pet-safe cleaning solution. The method includes providing an anhydrous solid unit dose composition and adding water to the anhydrous solid unit dose composition to form a ready-to-use solution. The anhydrous solid unit dose composition includes a surfactant system including one or more mild solid surfactants, a pH control system including a buffering agent, and a carrier. The ready-to-use solution has a pH of about 5.0 to about 8.0. The ready-to-use solution is configured for use in pet environments. The anhydrous solid unit dose composition is free of strong caustic alkalis, chlorine bleach, and peroxide bleach.

In some implementations, adding water includes adding about 30 mL to about 3,800 mL of water. In some implementations, the anhydrous solid unit dose composition dissolves in the water within about 1 minute to about 30 minutes. In some implementations, the ready-to-use solution has a pH of about 5.5 to about 6.5. In some implementations, the ready-to-use solution has a pH of about 6.0 to about 7.0. In some implementations, the anhydrous solid unit dose composition further includes an odor neutralization system including one or more of β-cyclodextrin, zinc ricinoleate, zeolite, or combinations thereof. In some implementations, the anhydrous solid unit dose composition further includes a bio-active system including one or more of enzymes, postbiotics, ferments, lysates, microbial derivatives, or combinations thereof. In some implementations, the bio-active system is activated upon adding water. In some implementations, the one or more mild solid surfactants are selected from the group consisting of sodium cocoyl isethionate, sodium lauryl sulfoacetate, sodium cocoyl glutamate, sodium cocoamphoacetate, and combinations thereof. In some implementations, the buffering agent includes a citric acid and sodium citrate buffer pair. In some implementations, the anhydrous solid unit dose composition is in the form of a powder, a granule, or a compressed tablet. In some implementations, the method further includes applying the ready-to-use solution to one or more of a hard surface, a fabric, air, a pet, or a litter system. In some implementations, the ready-to-use solution neutralizes odors through one or more of chemical binding, adsorption, or biological breakdown without reliance on fragrance masking. In some implementations, the ready-to-use solution has a rehydrated stability of about 1 month to about 12 months. In some implementations, the anhydrous solid unit dose composition is free of sodium lauryl sulfate, sodium laureth sulfate, ammonium lauryl sulfate, linear alkylbenzene sulfonates, alkylphenol ethoxylates, and nonylphenol ethoxylates. In some implementations, the anhydrous solid unit dose composition is free of volatile organic solvents, microplastics, and persistent synthetic polymers. In some implementations, the anhydrous solid unit dose composition further includes a preservation system, and the ready-to-use solution has a rehydrated stability of about 3 months to about 12 months. In some implementations, adding water includes adding water to a dispensing bottle, a bucket, a washer, or a basin. In some implementations, the anhydrous solid unit dose composition has a mass of about 0.2 g to about 453 g.

Various other implementations include an anhydrous solid unit dose composition for airborne odor neutralization. The composition includes an odor neutralization system, a pH control system including a buffering agent, and a carrier. The odor neutralization system includes one or more of an odor capture agent configured to capture volatile odor molecules, or an odor binding agent configured to bind amine or sulfur odor compounds. The composition is configured to be reconstituted with water at a point of use to form a ready-to-use solution for application to air or fabrics. The ready-to-use solution has a pH of about 5.0 to about 8.0. The composition is free of surfactants or includes a surfactant system at about 0 wt % to about 1 wt % of the unit dose. The composition is free of aerosolizable enzymes.

In some implementations, the odor capture agent includes β-cyclodextrin. In some implementations, the odor binding agent includes zinc ricinoleate. In some implementations, the odor neutralization system includes β-cyclodextrin and zinc ricinoleate. In some implementations, the odor neutralization system is present in an amount of about 1 wt % to about 15 wt % of the unit dose. In some implementations, the buffering agent includes a citric acid and sodium citrate buffer pair. In some implementations, the pH control system is present in an amount of about 0.5 wt % to about 10 wt % of the unit dose. In some implementations, the ready-to-use solution has a pH of about 6.0 to about 7.0. In some implementations, the carrier includes one or more of mannitol, sodium citrate, or sugar alcohols. In some implementations, the composition further includes a preservation system including one or more of gluconolactone, sodium benzoate, and potassium sorbate. In some implementations, the composition is in the form of a powder, a granule, or a compressed tablet. In some implementations, the composition is configured to be reconstituted with about 30 mL to about 500 mL of water. In some implementations, the ready-to-use solution is configured for delivery via a spray mister or atomizer. In some implementations, the composition is free of fragrance-based odor masking systems or includes a scent system at about 0 wt % to about 0.5 wt % of the unit dose. In some implementations, the scent system is encapsulated within the odor capture agent. In some implementations, the composition is free of strong caustic alkalis, chlorine bleach, and peroxide bleach. In some implementations, the composition is free of volatile organic solvents and volatile organic compound deodorizers. In some implementations, the ready-to-use solution has a rehydrated stability of about 6 months to about 12 months.

Various other implementations include an anhydrous solid unit dose composition for pet skin and coat care. The composition includes a surfactant system including one or more mild solid surfactants, a pH control system including a buffering agent, a skin comfort system including one or more conditioning or soothing agents, and a carrier. The composition is configured to be reconstituted with water at a point of use to form a ready-to-use solution for wash-off application to pet skin or coat. The ready-to-use solution has a pH of about 6.0 to about 7.0. The composition is free of strong caustic alkalis, chlorine bleach, and peroxide bleach.

In some implementations, the one or more mild solid surfactants are selected from the group consisting of sodium cocoyl isethionate, sodium lauryl sulfoacetate, sodium cocoyl glutamate, sodium cocoamphoacetate, coco glucoside, decyl glucoside, and combinations thereof. In some implementations, the surfactant system is present in an amount of about 15 wt % to about 40 wt % of the unit dose. In some implementations, the one or more conditioning or soothing agents are selected from the group consisting of betaine, panthenol, allantoin, aloe powder, sodium PCA, colloidal oatmeal, glyceryl oleate, and combinations thereof. In some implementations, the skin comfort system is present in an amount of about 0.5 wt % to about 15 wt % of the unit dose. In some implementations, the buffering agent includes a citric acid and sodium citrate buffer pair. In some implementations, the ready-to-use solution has a pH of about 6.5 to about 7.0. In some implementations, the composition further includes a bio-active system including one or more postbiotics selected from the group consisting of Lactobacillus ferment filtrate, Lactococcus ferment, Leuconostoc ferment, Saccharomyces ferment, Saccharomyces lysate, and combinations thereof. In some implementations, the bio-active system is present in an amount of about 0.05 wt % to about 2 wt % of the unit dose. In some implementations, the composition is free of bio-active systems. In some implementations, the composition further includes a preservation system including one or more of gluconolactone, sodium benzoate, potassium sorbate, phenoxyethanol, and ethylhexylglycerin. In some implementations, the composition is in the form of a powder, a granule, or a compressed tablet. In some implementations, the composition is configured to be reconstituted with about 200 mL to about 1,000 mL of water. In some implementations, the unit dose has a mass of about 8 g to about 30 g. In some implementations, the composition is configured for use as a pet shampoo. In some implementations, the composition is configured for use as a pet conditioner. In some implementations, the composition is configured for use as a paw cleanser. In some implementations, the composition is free of sodium lauryl sulfate, sodium laureth sulfate, silicones, and petroleum-based emollients. In some implementations, the ready-to-use solution has a rehydrated stability of about 4 months to about 9 months.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a schematic view of a system for pet-safe cleaning and odor neutralization using a water-activated composition, according to one implementation.

FIG. 2 is a schematic view of functional components of an anhydrous solid unit dose for pet-safe cleaning, according to another implementation.

FIG. 3 is a diagram view of a pH architecture comparing conventional cleaners with constrained pH ranges, according to another implementation.

FIG. 4 is a schematic view of an odor neutralization system comprising non-masking mechanisms for odor removal, according to another implementation.

FIG. 5 is a flowchart view of a method of preparing a pet-safe cleaning solution, according to another implementation.

### DETAILED DESCRIPTION

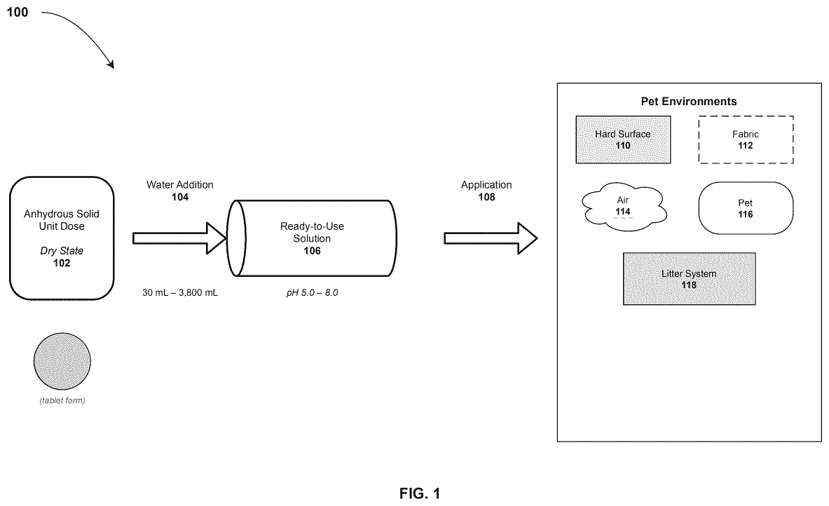

Referring to FIG. 1, a system 100 for pet-safe cleaning and odor neutralization using a water-activated composition is shown. The system 100 relates to anhydrous solid cleaning compositions configured for use in pet environments, where chemical tolerance is narrower than in conventional human-only cleaning products. The system 100 addresses the challenges of cleaning, deodorizing, and caring for surfaces, fabrics, air, and areas where pets live or contact.

The compositions of the present disclosure may be characterized as a constraint-driven chemical architecture that solves formulation requirements while maintaining chemical compatibility with pet safety constraints. Rather than optimizing for maximum cleaning power or shelf stability as primary objectives, the system architecture may be defined by the simultaneous satisfaction of multiple constraints including pet biological compatibility, ingredient co-existence requirements, and functional performance within narrower chemical boundaries than conventional cleaning products.

Bio-active components, when present in the compositions, may be inherently sensitive to pH drift, oxidizing agents, broad-spectrum biocides, certain surfactants, and ionic conditions. Accordingly, when bio-actives are present, the system may constrain pH governance within the pet-safe envelope, may exclude oxidizers and aggressive antimicrobial systems, and may require selection of compatible co-ingredients that do not denature or suppress biological function. The absence of bio-actives in other embodiments may reflect a deliberate design choice based on the required mechanism of action for a particular application, not a relaxation of system constraints.

Surfactants, particularly harsh anionic types, may disrupt protein structure at interfaces, increase dermal irritation risk, and exacerbate barrier disruption under repeated exposure. Accordingly, when surfactants are present, the system may constrain surfactant class to mild, low-irritancy chemistries, may constrain dosage to the minimum effective level, and may constrain use conditions to dilution-defined activation rather than concentrated exposure. Surfactants may be intentionally excluded from embodiments where physical soil removal is unnecessary or undesirable, such as air treatment applications, reinforcing that surfactants are optional tools within the system architecture rather than baseline components.

In embodiments where both surfactants and bio-actives are present, additional compatibility constraints may apply. Surfactants may be selected such that they do not denature or inhibit bio-active structures. Bio-actives may be selected such that they do not destabilize solution behavior or cause unintended activity drift. Ionic strength, chelation, and buffering may be balanced to support both surfactant and bio-active functions simultaneously. These co-existence constraints may substantially narrow viable formulation options and may exclude many conventional cleaning chemistries that rely on aggressive surfactants or extreme pH.

Where the reconstituted solution is intended to be stored and used over time, preservation may be required to maintain microbial control without violating pet-safety or bio-active compatibility constraints. Many robust preservation strategies used in conventional products may require extreme pH, may suppress biological activity, or may introduce irritant or volatile components. Accordingly, preservation in the disclosed system may be a tight-window design problem, solved by selecting preservation systems compatible with the pet-safe pH envelope, optional bio-actives when present, and intended exposure pathways including dermal contact, inhalation, and oral transfer through grooming.

The disclosed system may intentionally accept shorter post-rehydration shelf life than conventional ready-to-use liquid cleaners. This tradeoff may arise because solvent-heavy stabilization strategies are avoided, aggressive preservation and oxidation pathways are excluded, and chemical conditions are governed by pet exposure safety rather than maximum longevity. This characteristic may not be a deficiency but rather an intentional architectural decision to solve a constrained, multi-objective chemical problem within pet-safe boundaries.

The system 100 includes an anhydrous solid unit dose 102 provided in a dry state. The anhydrous solid unit dose 102 may be an anhydrous solid unit dose composition for cleaning in pet environments. The anhydrous solid unit dose 102 may be provided in various forms including powders, granules, or compressed tablets. The anhydrous solid unit dose 102 is chemically stable in dry form and does not require liquid preservatives, emulsifiers, solvents, or stabilizers typically used in bottled cleaners. Water is intentionally excluded from the anhydrous solid unit dose 102 until the moment of use.

With continued reference to FIG. 1, a water addition step 104 involves adding water to the anhydrous solid unit dose 102. The composition of the anhydrous solid unit dose 102 is configured to be reconstituted with water at a point of use to form a ready-to-use solution 106. The composition may be configured to be reconstituted with about 30 mL to about 3,800 mL of water. The amount of water added during the water addition step 104 determines the final strength and pH of the ready-to-use solution 106.

The ready-to-use solution 106 has a pH of about 5.0 to about 8.0. The ready-to-use solution 106 may be configured for use in a spray bottle, where the bottle acts as a reaction vessel rather than storage. The ready-to-use solution 106 may be configured for use in a bucket for larger volume cleaning applications. The ready-to-use solution 106 may be configured for use in a laundry washer, where agitation assists dissolution of the anhydrous solid unit dose 102.

The anhydrous solid unit dose 102 may be configured for a preferred consumer dilution volume of about 192 mL corresponding to standardized consumer containers. The anhydrous solid unit dose 102 may be configured for a preferred consumer dilution volume of about 532 mL corresponding to standardized consumer containers. Different unit doses may be purpose-built for different dilution volumes within the disclosed range, and no single unit dose is required to span all dilutions.

As further shown in FIG. 1, an application step 108 delivers the ready-to-use solution 106 to various pet environments. The ready-to-use solution 106 is configured for application to one or more of hard surfaces, fabrics, air, and litter systems. The application step 108 may deliver the ready-to-use solution 106 to a hard surface 110, a fabric 112, air 114, a pet 116, and a litter system 118. The hard surface 110 may include floors, countertops, crates, kennels, and other surfaces in pet environments. The fabric 112 may include pet bedding, carpets, upholstery, and laundry items that contact pets. The air 114 may include room air and enclosed spaces where pet odors accumulate. The pet 116 may include direct or indirect contact with dogs, cats, and other companion animals. The litter system 118 may include cat litter boxes and similar waste management systems.

The system 100 is water-defined rather than formula-defined. When a consumer adds water during the water addition step 104, the amount of water determines the final concentration and pH of the ready-to-use solution 106. The water-defined architecture allows high performance at low ingredient load, consistent chemistry across many formats, and easy scaling without changing the underlying formulation logic. The container used during the water addition step 104, whether a bottle, bucket, washer, or basin, acts as a reaction vessel rather than as storage for a pre-mixed liquid product.

Referring to FIG. 3, a pH architecture diagram comparing conventional cleaners with the constrained pH ranges of the anhydrous solid unit dose 102 is shown. The system 100 inverts traditional formulation logic by treating pH neutrality and biological compatibility as primary design constraints rather than secondary adjustments. In conventional cleaning products, the pH of the final solution is typically adjusted to optimize ingredient performance and formulation stability, allowing for wide pH ranges and enabling the use of harsher surfactants, strong builders, oxidizers, or masking fragrance systems. In contrast, the system 100 defines the acceptable pH range of the ready-to-use solution 106 first based on pet skin, paw, respiratory, and oral sensitivity, and ingredient selection is then constrained to materials that remain effective within that narrow pH window.

The pH constraints of the present disclosure may be informed by the physiological pH ranges of pet skin and saliva. Dog skin pH may range from about 6.2 to about 7.5. Cat skin pH may range from about 6.2 to about 7.5. Dog saliva pH may range from about 7.5 to about 8.0. Cat saliva pH may range from about 6.5 to about 7.5. These physiological pH ranges may define what is safe so as not to disrupt dermal or oral stability in pets.

If the pH of a cleaning or care product is outside of these physiological ranges, it may risk dermal barrier disruption and irritation. The skin barrier in dogs and cats may be more susceptible to pH-induced disruption than human skin, and products with pH values significantly above or below the skin pH range may compromise barrier function and cause irritation. If the pH is lower than about 5.5, causing higher acidity, this may impact the oral mucosa and increase stinging or irritation, which may be particularly relevant for products that may contact pet mouths through grooming behaviors or oral-adjacent applications.

These biological realities may inform the pH envelope of about 5.0 to about 8.0 disclosed herein, with narrower pH ranges for specific applications. Skin-contact applications such as shampoos, conditioners, and paw cleansers may have a ready-to-use pH of about 6.0 to about 7.0 to align with pet skin pH. Oral-adjacent applications may have a ready-to-use pH of about 6.0 to about 7.0 to align with pet saliva pH and minimize oral mucosa irritation. Leave-on and extended contact applications may have a ready-to-use pH of about 5.5 to about 6.8 to balance cleaning efficacy with skin compatibility. The pH control system comprising a buffering agent such as a citric acid and sodium citrate buffer pair may be configured to land the ready-to-use solution within these constrained pH ranges.

The compositions of the present disclosure may avoid harsh surfactants and irritants that are routine in human hard-surface or laundry chemistry. Pets may have fewer skin cell layers than humans and may rely on an intact skin barrier for protection. Pets may be more dependent on a healthy barrier than humans, and harsh surfactants such as sodium lauryl sulfate, sodium laureth sulfate, and ammonium lauryl sulfate may compromise the skin barrier through excessive defatting or irritation. The exclusion of these harsh surfactants from the compositions of the present disclosure may support maintenance of the pet skin barrier.

The compositions of the present disclosure may avoid leaving residues that function like broad biocides or oxidizers in routine-contact areas. Companion animals may have an oral microbiome that is part of normal health, and dysbiosis of the oral microbiome may be linked to disease states including periodontal disease and inflammation. Pets may groom surfaces that have been treated with cleaning products, and residues from broad-spectrum antimicrobial actives or oxidizers may be transferred to the oral cavity during grooming behaviors. This oral ecology constraint may limit routine use of oxidizers such as chlorine bleach and peroxide bleach, and broad antimicrobial actives, for general cleaning applications, especially where residues remain on surfaces that pets may contact or groom. The exclusion of chlorine bleach, peroxide bleach, and certain broad-spectrum antimicrobial actives from the compositions of the present disclosure may support maintenance of the pet oral microbiome.

The biological differences in olfactory systems between pets and humans may inform the scent and fragrance constraints of the present disclosure. Dogs may have approximately 300 million olfactory receptors, cats may have up to approximately 200 million olfactory receptors, and humans may have up to approximately 6 million olfactory receptors. This difference of approximately 30 to 50 times more olfactory receptors in pets compared to humans may have significant implications for fragrance selection and concentration in pet environment products.

Fragrances added to cleaning products to create a perception of cleanliness for humans may activate a disproportionately large number of olfactory receptors in dogs and cats. This activation may produce a level of sensory stimulation that can overstimulate pets, potentially resulting in behavioral responses, respiratory impact, stress-related responses, or combinations thereof. What may be perceived as a pleasant or clean scent by humans may be overwhelming or aversive to pets due to their heightened olfactory sensitivity.

With this biological difference, the constraint for odor management in pet environments may become not only how to eliminate odor for human perception but how to do so without causing negative reactions in pets. Additional constraints may include not only the initial sensory exposure but also the repeated inhalation exposure at floor level where pets occupy. As droplets of cleaning solutions fall to the floor, they may create stronger inhalation exposure for pets than for humans who occupy space at greater heights above the floor. Volatile fragrance compounds may also deposit on pet fur and paws, increasing paw-to-mouth transfer during grooming behaviors, which may create continued exposure pathways beyond the initial application.

These factors may impact both the odor neutralization system design and the selection of scents that may be added to products after odor neutralization. The scent system, if present, may be selected and dosed to be safely tolerated by both dogs and cats, taking into account their significantly more sensitive olfactory systems compared to humans.

With continued reference to FIG. 3, a pH scale 300 spans from pH 2.0 to pH 13.0. A prior art pH range 302 for conventional cleaners spans pH 2.0 to 12.5, representing the wide pH extremes used in traditional cleaning products. Human tolerance generally permits these chemical extremes, and product design in conventional cleaners is therefore driven primarily by ingredient compatibility and cleaning force rather than biological compatibility. Dogs and cats, however, have significantly lower tolerance to pH deviation, thinner skin barriers, and far more sensitive olfactory systems. Small changes in pH or volatile chemistry that are inconsequential to humans may cause irritation, aversion, or stress in animals.

As further shown in FIG. 3, the system 100 defines narrower, pet-safe pH ranges. A leave-on extended contact pH range 304 spans pH 5.5 to 6.8 and is applicable to stain and odor cleaners, urine cleaners, cat urine cleaners, and multi-surface cleaners. The leave-on extended contact pH range 304 supports enzyme longevity and activity, enables efficacy of preservation systems, minimizes ammonia volatilization, and provides safer conditions for pet exposure and sensitive surfaces. The ready-to-use solution 106 may have a pH of about 5.5 to about 6.5 when configured for hard surface and episodic cleaning applications within the leave-on extended contact pH range 304.

A wash-off short contact pH range 306 spans pH 6.7 to 7.0 and is applicable to shampoos, conditioners, paw cleansers, skunk cleansers, air purifiers, litter box deodorizers, itch relief sprays, flea and tick sprays, and skin disinfectants. The wash-off short contact pH range 306 accommodates higher wash-off tolerance, shorter in-use lifetime, and less reliance on bio-active activity, enabling optimization of skin feel, odor neutralization, and product-specific performance without breaking system-wide chemistry rules.

A leave-on oral-adjacent pH range 308 spans pH 6.0 to 7.0 and is applicable to paws and nose lotions, pet skin lotions, dog mouth wash sprays, and dog mouth wash water bowl additives. The leave-on oral-adjacent pH range 308 supports skin barrier integrity, oral tolerance, sensory acceptability, and rehydration stability. The ready-to-use solution 106 may have a pH of about 6.0 to about 7.0 when configured for leave-on, oral-adjacent, or skin-contact applications within the leave-on oral-adjacent pH range 308.

A pet-safe pH envelope 310 encompasses all pH ranges of the system 100 within pH 5.0 to 8.0, representing the constrained pH design space that maintains biological compatibility with pets. The pet-safe pH envelope 310 defines the absolute pH boundaries within which all embodiments of the anhydrous solid unit dose 102 operate after reconstitution during the water addition step 104. pH is meaningful for the system 100 after rehydration, and dry-state pH is chemically irrelevant.

The system 100 requires the simultaneous satisfaction of solution pH compatibility, ingredient efficacy within that pH range, and pet and environmental sensitivity requirements. This approach, where biology governs chemistry rather than chemistry dictating biological exposure, defines the formulation architecture. The instructions including dose amount, water volume, and agitation method are functional architecture elements rather than user preferences. Different unit doses are configured for different dilution volumes and use contexts, and the dose amount and water volume together determine the final pH landing within the pet-safe pH envelope 310.

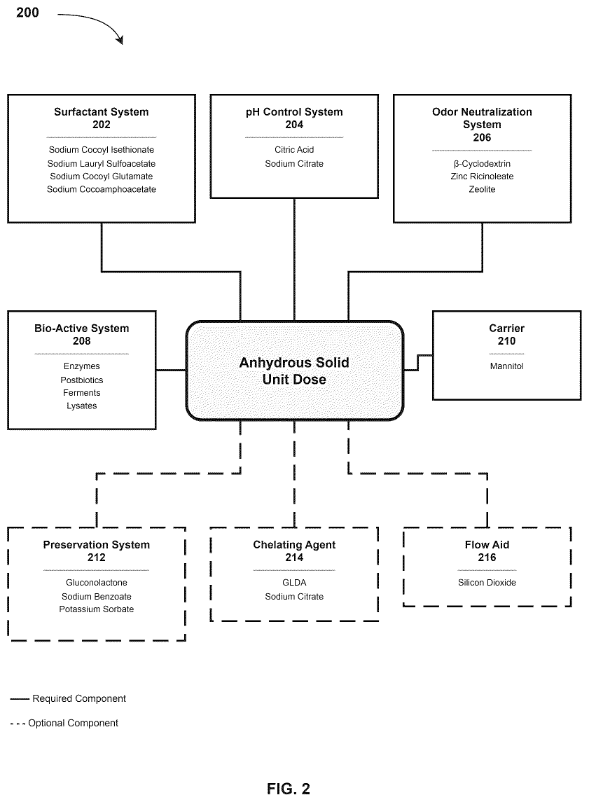

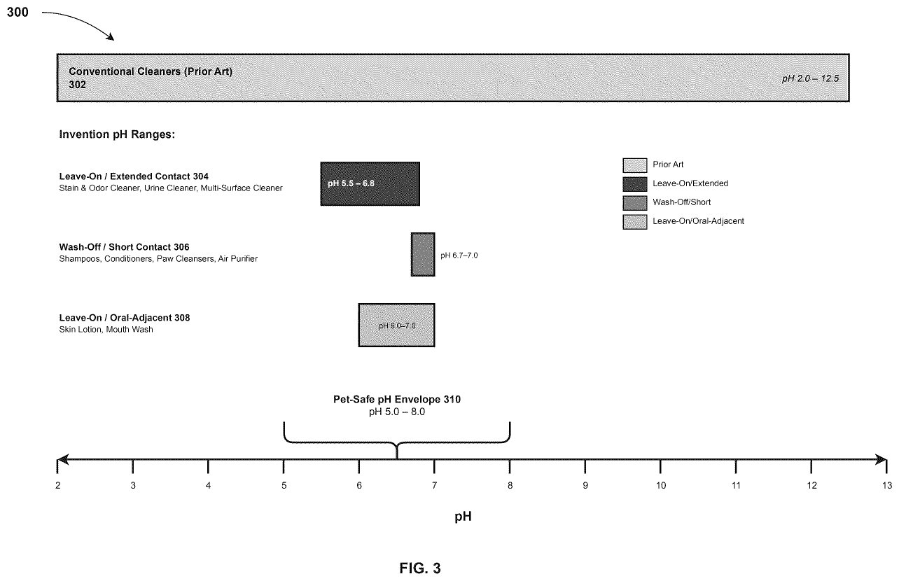

Referring to FIG. 2, an anhydrous solid unit dose 200 and the functional components of the anhydrous solid unit dose 200 are shown. The anhydrous solid unit dose 200 includes required components connected by solid lines and optional components connected by dashed lines. The anhydrous solid unit dose 200 may be an anhydrous solid unit dose composition for cleaning in pet environments, an anhydrous solid unit dose composition for odor neutralization, or an anhydrous solid unit dose composition for pet care. The anhydrous solid unit dose 200 is configured to be reconstituted with water at a point of use to form the ready-to-use solution 106, where the ready-to-use solution 106 has a pH of about 5.0 to about 8.0 as described previously with reference to the pet-safe pH envelope 310.

With continued reference to FIG. 2, the anhydrous solid unit dose 200 includes a surfactant system 202. The surfactant system 202 comprises one or more mild solid surfactants. The one or more mild solid surfactants may be selected from the group consisting of sodium cocoyl isethionate, sodium lauryl sulfoacetate, sodium cocoyl glutamate, sodium cocoamphoacetate, and combinations thereof. Sodium cocoyl isethionate is an amino acid-based surfactant that provides gentle cleansing action. Sodium lauryl sulfoacetate is a mild anionic solid surfactant distinct from harsher sulfate surfactants. Sodium cocoyl glutamate is an amino acid-derived surfactant compatible with pet skin sensitivity. Sodium cocoamphoacetate is an amphoteric surfactant that provides foam stabilization and mildness.

The surfactant system 202 is present in an amount of about 0.5 wt % to about 60 wt % of the unit dose. For spray and episodic cleaner embodiments, the surfactant system 202 may be present in an amount of about 8 wt % to about 35 wt % of the unit dose. For laundry tablet and detergent embodiments, the surfactant system 202 may be present in an amount of about 25 wt % to about 60 wt % of the unit dose. The total active chemical system content may range from about 0.01 wt % to about 60 wt % of the unit dose depending on the product format, where lower active loadings correspond to solid powders or tablets diluted into water and higher active loadings correspond to low-water, semi-solid, or specialty concentrate embodiments.

As further shown in FIG. 2, the anhydrous solid unit dose 200 is free of harsh surfactants. The composition is free of sodium lauryl sulfate, sodium laureth sulfate, ammonium lauryl sulfate, linear alkylbenzene sulfonates, alkylphenol ethoxylates, and nonylphenol ethoxylates. These excluded surfactants are commonly used in conventional cleaning products but may cause skin irritation, allergic reactions, or toxicity in pets. The exclusion of these harsh surfactants is a structural design constraint of the anhydrous solid unit dose 200 rather than an optional preference.

The anhydrous solid unit dose 200 is free of strong caustic alkalis, chlorine bleach, and peroxide bleach. The composition is free of oxidizing agents and denaturing agents that would impair bio-active function. The exclusion of strong caustic alkalis prevents excessive alkalinity that would otherwise increase odor volatilization, damage surfaces or fabrics, or irritate animal skin and airways. The exclusion of chlorine bleach and peroxide bleach maintains compatibility with the constrained pH architecture and bio-active systems of the anhydrous solid unit dose 200.

The anhydrous solid unit dose 200 may be free of fragrance-based odor masking systems or may comprise a scent system at about 0 wt % to about 5 wt % of the unit dose, but preferably at about 0 wt % to about 1 wt % of the unit dose. When a scent system is present, the scent system is kept intentionally low to avoid aversion and masking behavior in pets. Fragrance, if present at all, is optional and minimal, and is not required for efficacy of the anhydrous solid unit dose 200. The ready-to-use solution 106 formed from the anhydrous solid unit dose 200 is configured for use in pet environments including the hard surface 110, the fabric 112, the air 114, the pet 116, and the litter system 118 as described previously with reference to FIG. 1.

The anhydrous solid unit dose 200 includes a pH control system 204 comprising a buffering agent. The buffering agent may comprise a citric acid and sodium citrate buffer pair. Citric acid provides acidic buffering capacity while sodium citrate provides alkaline buffering capacity, and the combination of citric acid and sodium citrate forms a buffer pair that maintains the pH of the ready-to-use solution 106 within the pet-safe pH envelope 310 described previously. The citric acid and sodium citrate buffer pair controls pH gently without relying on strong bases or strong acids.

The pH control system 204 is present in an amount of about 0.1 wt % to about 15 wt % of the unit dose. For spray cleaner embodiments, the pH control system 204 may be present in an amount of about 1 wt % to about 12 wt % of the unit dose. For laundry tablet embodiments, the pH control system 204 may include chelation and buffer system content of about 5 wt % to about 25 wt % for hard water robustness. The amount of the pH control system 204 is selected based on the target pH range for the intended application, whether within the leave-on extended contact pH range 304, the wash-off short contact pH range 306, or the leave-on oral-adjacent pH range 308.

The pH control system 204 uses buffer pairs and chelators to control pH gently, prevent excessive alkalinity or acidity, and maintain conditions compatible with enzymes and sensitive surfaces. The buffering agent maintains the pH of the ready-to-use solution 106 within the constrained ranges that support enzyme longevity and activity when bio-active systems are present. The pH control system 204 prevents pH drift that would otherwise compromise preservation system efficacy or cause irritation to pet skin, paws, respiratory systems, or oral tissues.

The anhydrous solid unit dose 200 avoids strong bases and acids that would otherwise increase odor volatilization, damage surfaces or fabrics, or irritate animal skin and airways. The exclusion of strong caustic alkalis such as sodium hydroxide and sodium metasilicate prevents excessive alkalinity that would volatilize ammonia from urine-based soils, increasing rather than decreasing odor perception. The exclusion of strong acids prevents surface damage and skin irritation that would result from pH values below the pet-safe pH envelope 310. The pH control system 204 achieves effective cleaning and odor neutralization performance within the narrower pH boundaries defined by pet biological compatibility rather than forcing pH to accommodate otherwise incompatible ingredients.

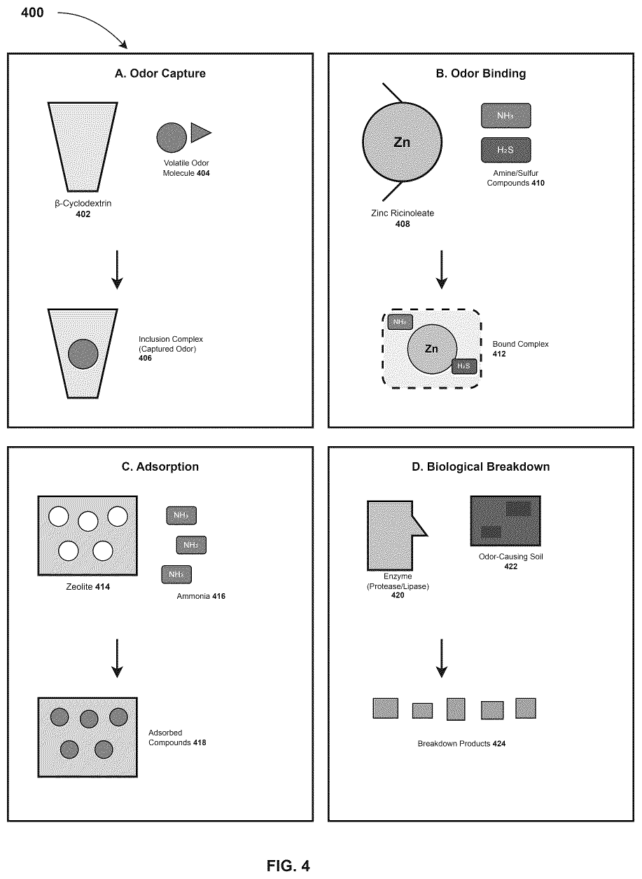

Referring to FIG. 4, an odor neutralization system 400 comprising four non-masking mechanisms for odor removal is shown. The odor neutralization system 400 may be included in the anhydrous solid unit dose 200 described previously with reference to FIG. 2. The odor neutralization system 400 comprises one or more of an odor capture agent configured to capture volatile odor molecules, an odor binding agent configured to bind amine or sulfur odor compounds, or an adsorbent configured to adsorb ammonia-related compounds. The odor neutralization system 400 is present in an amount of about 0.5 wt % to about 20 wt % of the unit dose. For spray embodiments, the odor neutralization system 400 may be present in an amount of about 0.5 wt % to about 8 wt % of the unit dose. For litter and fabric embodiments, the odor neutralization system 400 may be present in an amount of about 1 wt % to about 20 wt % of the unit dose.

With continued reference to FIG. 4, Panel A shows odor capture using β-cyclodextrin 402. The β-cyclodextrin 402 functions as an odor capture agent. The β-cyclodextrin 402 has a truncated cone-shaped molecular structure with a hydrophobic cavity. A volatile odor molecule 404 approaches the β-cyclodextrin 402 and is captured within the cavity of the β-cyclodextrin 402 to form an inclusion complex 406. The inclusion complex 406 traps the volatile odor molecule 404 through host-guest chemistry, preventing the volatile odor molecule 404 from reaching olfactory receptors. The β-cyclodextrin 402 may be provided in spray-dried form for compatibility with the anhydrous solid unit dose 200. The odor capture agent comprising the β-cyclodextrin 402 is configured to capture volatile odor molecules without relying on fragrance masking.

As further shown in FIG. 4, Panel B shows odor binding using zinc ricinoleate 408. The zinc ricinoleate 408 functions as an odor binding agent. Amine sulfur compounds 410 including ammonia (NH₃) and hydrogen sulfide (H₂S) are chemically bound to the zinc ricinoleate 408 to form a bound complex 412. The zinc ricinoleate 408 works by adsorption, complexation, and bonding mechanisms to neutralize amine and sulfur odor compounds. The odor binding agent comprising the zinc ricinoleate 408 is configured to bind amine or sulfur odor compounds. The zinc ricinoleate 408 may be provided in a supported or pre-dispersed form on a carrier for compatibility with the anhydrous solid unit dose 200.

Panel C of FIG. 4 shows adsorption using zeolite 414. The zeolite 414 functions as an adsorbent. Ammonia compounds 416 are drawn into the porous crystalline structure of the zeolite 414 where the ammonia compounds 416 become adsorbed compounds 418 trapped within the zeolite pores. The adsorbent comprising the zeolite 414 is configured to adsorb ammonia-related compounds. The zeolite 414 may be zeolite A or a similar zeolite structure selected for ammonia adsorption capacity. The zeolite 414 is particularly effective in litter box deodorizer applications where ammonia control is a primary concern.

Panel D of FIG. 4 shows biological breakdown using an enzyme 420. The enzyme 420 may be a protease, lipase, amylase, or other enzyme selected for degradation of odor-causing substrates. The enzyme 420 acts on an odor-causing soil 422 to catalytically break down the odor-causing soil 422 into smaller breakdown products 424 that no longer produce odor. The enzyme 420 reduces odor source over time through substrate breakdown rather than masking. The enzyme 420 may be provided in granulated or encapsulated form for stability in the anhydrous solid unit dose 200.

The odor neutralization system 400 may comprise β-cyclodextrin and zinc ricinoleate. The odor neutralization system 400 may comprise β-cyclodextrin, zinc ricinoleate, and zeolite. The combination of multiple odor neutralization mechanisms provides broad-spectrum odor control across different odor chemistries encountered in pet environments. The ready-to-use solution 106 neutralizes odors through one or more of chemical binding, adsorption, or biological breakdown without reliance on fragrance masking.

The anhydrous solid unit dose 200 may be configured for skunk odor removal applications requiring specific odor binding and neutralization chemistry. Skunk odor removal applications may utilize higher loadings of the zinc ricinoleate 408 for binding sulfur-containing thiol compounds characteristic of skunk spray. The anhydrous solid unit dose 200 may be configured for litter box deodorizer applications with higher adsorbent loading for ammonia control. Litter box deodorizer applications may utilize higher loadings of the zeolite 414 within the odor neutralization system 400 to address ammonia volatilization from cat urine.

The anhydrous solid unit dose 200 may be configured for air purifier applications without content and optimized for pump spray delivery. Air purifier applications may emphasize the β-cyclodextrin 402 for capture of volatile odor molecules in room air without surfactant content to avoid residue on surfaces. The anhydrous solid unit dose 200 may be configured for cat urine cleaner applications with enhanced enzyme systems targeting feline urine chemistry. Cat urine cleaner applications may include urease within the enzyme 420 component to break down urea-based odor precursors specific to feline urine.

The anhydrous solid unit dose 200 is free of high-terpene essential oil loads. The anhydrous solid unit dose 200 is free of volatile organic solvent deodorizers. The anhydrous solid unit dose 200 is free of fragrance-based odor masking systems or comprises a scent system at about 0 wt % to about 5 wt % of the unit dose, but preferably at about 0 wt % to about 1 wt % of the unit dose, as described previously. These exclusions distinguish the odor neutralization system 400 from conventional deodorizing products that rely on masking-first synthetic fragrances, high-terpene essential oil loads, or volatile organic compound solvent deodorizers to conceal rather than neutralize odors. The odor neutralization system 400 addresses odors by chemically binding odor molecules, adsorbing ammonia-related compounds, and biologically breaking down odor-causing soils rather than overwhelming the environment with scent.

The anhydrous solid unit dose 200 includes a bio-active system 208 comprising one or more of enzymes, postbiotics, ferments, lysates, microbial derivatives, or combinations thereof. The bio-active system 208 is configured to break down odor-causing soils through biological or catalytic mechanisms. The bio-active system 208 remains stable in the anhydrous solid unit dose 200 in a dry anhydrous form and is activated upon reconstitution with water during the water addition step 104. The bio-active system 208 enables effective biological cleaning and odor removal without requiring live microbial growth, liquid preservation, or harsh chemical conditions during storage.

The bio-active system 208 may comprise one or more enzymes selected from the group consisting of protease, amylase, lipase, cellulase, urease, and combinations thereof. Protease breaks down protein-based soils and stains including those from pet accidents, food residues, and biological matter. Amylase breaks down starch-based soils and carbohydrate residues. Lipase breaks down fat-based soils and oily residues. Cellulase breaks down cellulose-based fibers and assists with fabric care applications. Urease breaks down urea-based odor compounds in pet urine applications, providing targeted degradation of urine-specific odor precursors. The enzyme 420 described previously with reference to the odor neutralization system 400 may be selected from these enzyme types based on the intended application of the anhydrous solid unit dose 200.

The bio-active system 208 may comprise an enzyme system present in an amount of about 0 wt % to about 20 wt % of the unit dose, expressed on an activity-equivalent basis. Enzymes may be omitted entirely where chemical binding or adsorption is sufficient, where biological degradation is unnecessary, or where regulatory context discourages enzyme use. Laundry and heavy-soil embodiments may include enzyme system content at the upper end of the range. Air and cosmetic-adjacent products may include enzyme system content at zero or near zero. Enzymes are preferred for cleaner formulations where substrate breakdown provides odor reduction over time as described previously with reference to the breakdown products 424.

The bio-active system 208 may comprise one or more postbiotics selected from the group consisting of Lactobacillus ferment filtrate, Lactococcus ferment, Leuconostoc ferment, Saccharomyces ferment, Saccharomyces lysate, and combinations thereof. Lactobacillus ferment filtrate may be provided in powder form for compatibility with the anhydrous solid unit dose 200. Lactococcus and Leuconostoc ferments may be provided in powder form and contribute to skin microbiome support in grooming applications. Saccharomyces ferment and Saccharomyces lysate may be provided in powder form and provide conditioning benefits for pet skin and coat applications. Postbiotics are preferred for shampoo formulations where skin comfort and microbiome compatibility are primary considerations.

The bio-active system 208 is present in an amount of about 0.001 wt % to about 10 wt % of the unit dose, expressed on an active or dry-basis equivalent. The bio-active system 208 includes enzymes, postbiotics, ferments, lysates, and microbial derivatives, and the total bio-derived system content falls within this range. Live microbial growth is not required for the bio-active system 208 to function, and biological components may be selectively included or excluded depending on the formulation architecture, intended use, regulatory context, and desired stability profile.

The bio-active system 208 may include enzymatic-producing biological materials such as enzymatic-producing bacteria or microbial preparations provided in dry anhydrous form. Such enzymatic-producing biological materials may release enzymes upon hydration during the water addition step 104. The enzymatic-producing biological materials may contribute enzyme activity through non-replicating biological structures or may act as a source of enzymatic or catalytic activity after reconstitution to form the ready-to-use solution 106. The bio-active system 208 does not require live microbial growth, replication, or sustained metabolic activity in order to function. Where enzymatic-producing bacteria are included, the enzymatic-producing bacteria are selected and formulated such that the enzymatic-producing bacteria remain stable in the dry state, activation occurs after hydration, function does not rely on uncontrolled growth or replication, and activity is compatible with the pH ranges and pet-sensitivity constraints of the anhydrous solid unit dose 200.

In preferred embodiments, non-living bio-active systems including purified enzymes, enzyme complexes, postbiotics, ferments, lysates, or combinations thereof are used due to predictability, stability, and compatibility with the buffered, pet-safe chemical environment of the anhydrous solid unit dose 200. The bio-active system 208 is activated upon adding water during the water addition step 104, and functional performance occurs after dilution with water at the time of use. The pH of the ready-to-use solution 106 is maintained within ranges compatible with biological activity through the pH control system 204 using buffered systems rather than caustic adjustment as described previously.

The anhydrous solid unit dose 200 is configured such that the bio-active system 208 coexists with preservation systems when both are present. If incompatibility exists between enzymes and preservation, the enzymes are removed rather than the preservation system. The preservation system is not compromised to accommodate enzyme activity, and the formulation architecture maintains preservation efficacy as a priority for post-dilution stability of the ready-to-use solution 106. The bio-active system 208 is selected to be compatible with the preservation system at the pH of the ready-to-use solution 106 within the pet-safe pH envelope 310.

The anhydrous solid unit dose 200 includes a carrier 210. The carrier 210 comprises mannitol. The mannitol may be provided in spray-dried form or directly compressible form for compatibility with the solid processing requirements of the anhydrous solid unit dose 200. Spray-dried mannitol provides controlled particle size distribution and flow characteristics suitable for powder blending operations. Directly compressible mannitol provides binding properties suitable for tablet compression without requiring additional granulation steps. The carrier 210 functions as a bulk material that supports the active components of the anhydrous solid unit dose 200 and facilitates dissolution during the water addition step 104 to form the ready-to-use solution 106.

The anhydrous solid unit dose 200 includes a solid structure system comprising carriers, binders, disintegrants, fillers, and processing aids. The solid structure system is present in an amount of about 5 wt % to about 95 wt % of the unit dose. The solid structure system content varies depending on the product format and active ingredient loading of the anhydrous solid unit dose 200. Embodiments with higher active ingredient loadings may include solid structure system content at the lower end of the range, while embodiments with lower active ingredient loadings may include solid structure system content at the higher end of the range.

The solid structure system may include sorbitol as a binder and dissolution aid for tablet formulations. Sorbitol provides binding properties during tablet compression and assists with dissolution of the compressed tablet during the water addition step 104. The solid structure system may include sodium sulfate as a filler and flow agent particularly for tablet embodiments. Sodium sulfate provides bulk to the formulation and assists with powder flow during manufacturing operations.

The solid structure system may include sodium bicarbonate as a disintegration base for tablet formulations to provide controlled CO₂ release during dissolution. The controlled CO₂ release from sodium bicarbonate assists with tablet breakup and dispersion when the anhydrous solid unit dose 200 contacts water during the water addition step 104. The solid structure system may include disintegration aids specifically formulated for tablet embodiments to control dissolution rate. The disintegration aids may be selected based on the target dissolution time of about 1 minute to about 30 minutes for the anhydrous solid unit dose 200.

The composition may include sodium carboxymethyl cellulose as an anti-redeposition agent for laundry applications. Sodium carboxymethyl cellulose is a plant-derived material that prevents removed soils from redepositing onto fabrics during wash cycles. The sodium carboxymethyl cellulose may be present in laundry tablet embodiments of the anhydrous solid unit dose 200 where anti-redeposition performance is a consideration.

The anhydrous solid unit dose 200 includes a flow aid 216. The flow aid 216 comprises silicon dioxide. The silicon dioxide assists in processing of the anhydrous solid composition and prevents caking during storage. The flow aid 216 comprising silicon dioxide provides anti-caking properties that maintain the free-flowing characteristics of powder embodiments of the anhydrous solid unit dose 200. The silicon dioxide may be present in an amount sufficient to maintain powder flow without contributing to residue formation in the ready-to-use solution 106.

The anhydrous solid unit dose 200 may include a preservation system 212. The preservation system 212 comprises one or more of gluconolactone, sodium benzoate, potassium sorbate, phenoxyethanol, and ethylhexylglycerin. The preservation system 212 is present in an amount of about 0 wt % to about 8 wt % of the unit dose. The preservation system 212 is selected based on the rehydrated stability target of about 1 month to about 12 months for the ready-to-use solution 106. Preservation is justified by post-dilution storage and use rather than dry storage, and the preservation system 212 is evaluated based on performance after reconstitution during the water addition step 104.

The preservation system 212 may include gluconolactone and sodium benzoate as a combined preservation system referred to as GSB. The GSB preservation system provides efficacy at the pH ranges within the pet-safe pH envelope 310 described previously. The GSB preservation system is the backbone for long post-mix life in embodiments requiring extended rehydrated stability. The preservation system 212 may include potassium sorbate as a booster preservative that enhances the efficacy of the primary preservation components. Potassium sorbate is pH-dependent and functions within the acidic to neutral pH ranges of the ready-to-use solution 106.

The preservation system 212 may include phenoxyethanol for neutral pH capable preservation. Phenoxyethanol may be delivered on solid carriers such as microcrystalline cellulose or starch carriers for solid-delivered liquid preservatives compatible with the anhydrous solid unit dose 200. The solid carrier delivery of phenoxyethanol maintains the anhydrous character of the unit dose while providing effective preservation after reconstitution. The preservation system 212 may include ethylhexylglycerin as a preservation booster that enhances the efficacy of other preservative components. Ethylhexylglycerin is pH-dependent and functions in combination with primary preservatives within the preservation system 212.

The preservation system 212 is compatible with the bio-active system 208 at the pH of the ready-to-use solution 106. The preservation system 212 is selected such that preservation efficacy is maintained without impairing the function of enzymes, postbiotics, ferments, lysates, or other bio-active components within the bio-active system 208. The ready-to-use solution 106 may have a rehydrated stability of about 3 months to about 12 months when the anhydrous solid unit dose 200 includes the preservation system 212. Leave-on, medical-adjacent, and oral-adjacent products may have rehydrated stability of about 3 months to about 6 months. Hard surface and episodic cleaners may have rehydrated stability of about 6 months to about 12 months. Skin-contact cleansing and conditioning products may have rehydrated stability of about 4 months to about 9 months.

The anhydrous solid unit dose 200 may include a chelating agent 214. The chelating agent 214 may be selected from the group consisting of tetrasodium glutamate diacetate, sodium citrate, and combinations thereof. Tetrasodium glutamate diacetate, also referred to as GLDA, is a biodegradable chelator that provides hard-water control without the environmental concerns associated with phosphate-based chelators. Sodium citrate provides dual function as both a chelating agent and a pH buffering component within the pH control system 204 described previously. The chelating agent 214 sequesters calcium and magnesium ions in hard water that would otherwise interfere with surfactant performance and cause film or spotting on surfaces.

The chelating agent 214 comprising tetrasodium glutamate diacetate may be present in an amount of about 0.2 wt % to about 5 wt % of the unit dose depending on the intended application. For spray cleaner embodiments, the chelating agent 214 may be present in an amount of about 0.2 wt % to about 3 wt % of the unit dose. For laundry tablet embodiments requiring hard water robustness, the chelating agent 214 may be present in higher amounts within the chelation and buffer system content of about 5 wt % to about 25 wt % of the unit dose. The chelating agent 214 is excluded from phosphate-based chelators such as sodium tripolyphosphate and trisodium phosphate, and is excluded from phosphonate-based chelators, maintaining the biodegradable and pet-safe character of the anhydrous solid unit dose 200.

The anhydrous solid unit dose 200 may include a skin comfort system for embodiments configured for application to the pet 116. In some implementations, the skin comfort system comprises one or more of betaine, panthenol, allantoin, aloe powder, sodium PCA, colloidal oatmeal, or combinations thereof. The skin comfort system is present in an amount of about 0 wt % to about 35 wt % of the unit dose. Higher loadings of the skin comfort system apply to lotion and leave-on solid embodiments, while lower loadings apply to cleaner embodiments where skin contact is incidental rather than primary.

Betaine provides humectant and skin conditioning properties in the skin comfort system. Panthenol may be provided in powder form and provides moisturizing and skin barrier support. Allantoin provides soothing properties for irritated or sensitive pet skin. Aloe powder may be provided as aloe vera 200× powder, a concentrated form that delivers aloe benefits at low inclusion levels compatible with the anhydrous solid unit dose 200. Sodium PCA provides humectant properties that support skin hydration in leave-on formulations. Colloidal oatmeal may be provided in ultrafine form with controlled particle size distribution and provides soothing and anti-itch properties for pet skin applications.

The skin comfort system may include MCT oil powder in spray-dried form for lipid delivery in leave-on formulations. The MCT oil powder provides emollient properties while maintaining compatibility with the anhydrous solid format of the unit dose. The skin comfort system may include sunflower lecithin powder for emollient properties in pet care formulations. Sunflower lecithin powder provides skin conditioning benefits and assists with dispersion of lipid-based components in the ready-to-use solution 106.

The anhydrous solid unit dose 200 may include xanthan gum or sclerotium gum as rheology modifiers for controlling solution viscosity of the ready-to-use solution 106. Xanthan gum provides thickening and suspension properties in aqueous solutions. Sclerotium gum provides similar rheology modification with a different sensory profile. The rheology modifiers may be included in shampoo, conditioner, and lotion embodiments where solution viscosity affects application and performance.

The anhydrous solid unit dose 200 may include an antiseptic system for medicated skin care applications. The antiseptic system may include chlorhexidine provided as chlorhexidine diacetate powder or spray-dried solid equivalent. Chlorhexidine provides antimicrobial activity for skin disinfectant and relief applications within the wash-off short contact pH range 306 described previously. The chlorhexidine may be expressed as chlorhexidine gluconate equivalent in the ready-to-use solution 106 after reconstitution during the water addition step 104.

The anhydrous solid unit dose 200 may include a scent system at about 0 wt % to about 5 wt % of the unit dose, but preferably at about 0 wt % to about 1 wt % of the unit dose. The scent system is optional and is not required for efficacy of the anhydrous solid unit dose 200. When present, the scent system is kept intentionally low to avoid aversion in pets and to avoid masking behavior that would conceal rather than neutralize odors. The scent system may include encapsulated fragrance for controlled release and reduced volatility. The scent system is not a fragrance-based odor masking system, and the anhydrous solid unit dose 200 relies on the odor neutralization system 400 described previously for odor control rather than fragrance masking.

The anhydrous solid unit dose composition includes structural exclusions that enable the system to function as intended within the constrained chemical boundaries described previously. These exclusions are structural rather than optional and define the chemical architecture of the composition.

The composition is free of strong caustic alkalis, chlorine bleach, and peroxide bleach as described previously. The composition excludes strong alkalinity builders such as sodium metasilicate, sodium hydroxide, and potassium hydroxide. These strong alkalinity builders would force pH outside the pet-safe pH envelope and would increase ammonia volatilization from urine-based soils rather than neutralizing odors. The exclusion of strong caustic alkalis maintains the buffered pH control architecture that enables effective cleaning within biologically compatible pH ranges.

The composition is free of volatile organic solvents. Volatile organic solvents are excluded because such solvents would compromise the anhydrous solid delivery format and would introduce respiratory hazards incompatible with pet environments. The exclusion of volatile organic solvents maintains the water-defined activation architecture where water added at the point of use determines the final solution characteristics.

The composition is free of microplastics and persistent synthetic polymers. The composition excludes microplastic encapsulates that would persist in the environment after use. The exclusion of microplastics and persistent synthetic polymers maintains environmental compatibility and prevents accumulation of non-biodegradable materials in pet environments.

The composition is free of isothiazolinones including methylisothiazolinone, methylchloroisothiazolinone, and benzisothiazolinone. The composition excludes formaldehyde-releasing preservatives. These excluded preservatives are associated with sensitization and irritation concerns that are incompatible with the pet-safe system architecture. The preservation system described previously relies on gluconolactone, sodium benzoate, potassium sorbate, phenoxyethanol, and ethylhexylglycerin rather than these excluded preservative classes.

The composition is free of PEG/PPG film-formers, polyquaterniums, and acrylic thickeners. The composition excludes PEG-based binders for tablet formulations. The composition excludes PVA and PVP film coatings for tablets. These excluded materials are replaced by the mannitol carrier, sorbitol binder, and other solid structure system components described previously that maintain compatibility with the pet-safe and biodegradable system architecture.

The composition is free of fragrance-based odor masking systems as described previously, or comprises a scent system at about 0 wt % to about 5 wt % of the unit dose, but preferably at about 0 wt % to about 1 wt % of the unit dose. The exclusion of fragrance-based odor masking systems distinguishes the composition from conventional products that rely on overwhelming scent to conceal odors rather than neutralizing odors through the chemical binding, adsorption, and biological breakdown mechanisms described previously.

The composition is free of sodium lauryl sulfate, sodium laureth sulfate, ammonium lauryl sulfate, linear alkylbenzene sulfonates, alkylphenol ethoxylates, and nonylphenol ethoxylates as described previously. These harsh surfactants are excluded in favor of the mild solid surfactants within the surfactant system including sodium cocoyl isethionate, sodium lauryl sulfoacetate, sodium cocoyl glutamate, and sodium cocoamphoacetate.

The composition excludes optical brighteners as incompatible with the pet-safe system architecture. Optical brighteners are fluorescent compounds used in conventional laundry products that may cause skin sensitization and are unnecessary for pet care applications where visual whitening is not a performance requirement.

The composition excludes TAED activators as incompatible with the enzyme-compatible system architecture. TAED activators are peroxide bleach activators that would generate oxidizing conditions incompatible with the bio-active system and the exclusion of peroxide bleach described previously.

The composition excludes quaternary ammonium fabric softeners as incompatible with the pet-safe system. Quaternary ammonium compounds may cause skin irritation and are excluded from the formulation architecture in favor of conditioning agents within the skin comfort system described previously.

The composition excludes enzyme-incompatible solvents to maintain bio-active system function. Solvents that would denature or inactivate enzymes, postbiotics, ferments, lysates, or other bio-active components are excluded to maintain the stability and activation characteristics of the bio-active system upon reconstitution with water.

In some implementations, the composition excludes live bacteria that require replication or sustained metabolic activity to function. The bio-active system described previously may include enzymatic-producing biological materials, but such materials function through enzyme release upon hydration or through non-replicating biological structures rather than through live microbial growth or sustained metabolic activity.

The composition excludes phosphates and phosphonates as chelating agents. Phosphate-based chelators such as sodium tripolyphosphate and trisodium phosphate are excluded in favor of biodegradable chelators including tetrasodium glutamate diacetate and sodium citrate within the chelating agent described previously.

The composition excludes triclosan and triclocarban as antiseptic agents. The composition excludes phenolic disinfectants. These excluded antiseptic agents are associated with environmental persistence, endocrine disruption concerns, or toxicity profiles incompatible with the pet-safe system architecture. Antiseptic applications within the system utilize chlorhexidine as described previously rather than these excluded antiseptic classes.

The composition excludes liquid-only stabilizers and preservatives that would require water content during storage. The anhydrous solid delivery format excludes emulsifiers, liquid solvents, and stabilizers typically used in bottled cleaners, maintaining the water-defined activation architecture where the composition remains stable in dry form until reconstitution at the point of use. The composition may be configured to exclude stabilizers, solubilizers, hydrotropes, co-solvents, and preservation aids that are required primarily to maintain ingredient compatibility, phase stability, or microbial control during prolonged aqueous storage. In conventional liquid cleaning formulations, such ingredients may collectively comprise several percent by weight of the total composition, and in some implementations greater than about 5 wt % to about 10 wt %, functioning primarily to stabilize the formulation in the presence of stored water rather than to contribute directly to cleaning performance, odor neutralization, or pet safety.

The anhydrous solid unit dose composition may be provided in various physical formats including a powder, a granule, or a compressed tablet. The powder format provides rapid dissolution characteristics and flexibility in dosing for consumer applications. The granule format provides controlled particle size distribution and flow characteristics suitable for pre-measured packaging. The compressed tablet format provides precise dosing, compact storage, and durability during shipping and handling.

The anhydrous solid unit dose may be provided as a pre-measured sachet for single-use consumer convenience. The pre-measured sachet contains a powder or granule formulation in a sealed packet configured for a specific dilution volume. The pre-measured sachet format eliminates the need for consumer measurement and provides consistent dosing across uses. The anhydrous solid unit dose may be provided as a dissolvable unit configured for specific dilution volumes. The dissolvable unit may be a compressed tablet or other solid form designed to dissolve completely when added to a predetermined volume of water.

The unit dose has a mass of about 0.2 g to about 453 g. Sub-gram doses within the range of about 0.2 g to about 1 g may be configured for medical-adjacent, oral-adjacent, or spot-treatment applications where small volumes and precise dosing are considerations. Doses of about 4 g to about 25 g may be configured for bottle or bucket dilution applications where consumer convenience and moderate solution volumes are considerations. Doses of about 8 g to about 30 g may be configured for laundry or washer-based systems where larger solution volumes and higher active ingredient loading are considerations. Doses of about 100 g or greater may be configured for bulk or commercial dilution applications. No single unit dose is required to operate across the entire mass range, and different unit doses may be purpose-built for different applications within the disclosed range.

The composition is configured to be reconstituted with about 30 mL to about 3,800 mL of water as described previously. Very small dilution volumes of about 30 mL may be configured for dropper or medical-adjacent applications. Preferred consumer dilution volumes of about 192 mL and about 532 mL correspond to standardized consumer spray bottle containers. Large dilution volumes of about 3,800 mL may be configured for gallon containers, washers, or commercial applications. The dilution volume and unit dose mass together determine the resulting in-use formulation concentration after dilution, which may range from about 0.001 wt % to about 10 wt % total formulation solids. Very dilute air or oral-adjacent uses may result in formulation concentrations at the lower end of the range, while concentrated wash systems may result in formulation concentrations at the higher end of the range.

The composition dissolves in water within about 1 minute to about 30 minutes. The dissolution time may be controlled through selection of binder materials and compression parameters to achieve dissolution within about 1 minute to about 15 minutes as a preferred range. Powder formats may dissolve more rapidly than compressed tablet formats due to increased surface area exposure to water. Compressed tablet formats may require longer dissolution times but provide advantages in dosing precision and storage stability. The dissolution time varies based on unit dose format, binder selection, agitation method, and intended use. Manual shaking in a spray bottle may provide different dissolution characteristics than washer agitation in a laundry application. Slower dissolution formats such as compressed tablets remain within scope so long as functional rehydration occurs prior to use.

The tablet shape may be designed to fit inside common bottle threads such as 28-410 or 38-400 thread sizes. The 28-410 thread size corresponds to a common spray bottle closure diameter, allowing the compressed tablet to be inserted directly into the bottle through the neck opening before adding water. The 38-400 thread size corresponds to a larger bottle closure diameter suitable for larger tablet formats or higher-dose applications. The tablet shape designed to fit inside common bottle threads provides consumer convenience by allowing direct insertion of the tablet into the container that will serve as the reaction vessel during dissolution. Custom binder blends may be selected to provide tablet strength during handling and shipping while maintaining dissolution characteristics within the disclosed time ranges.

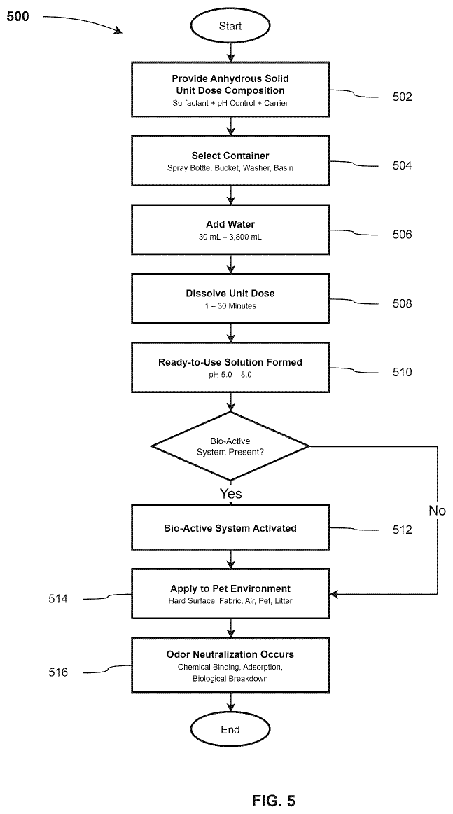

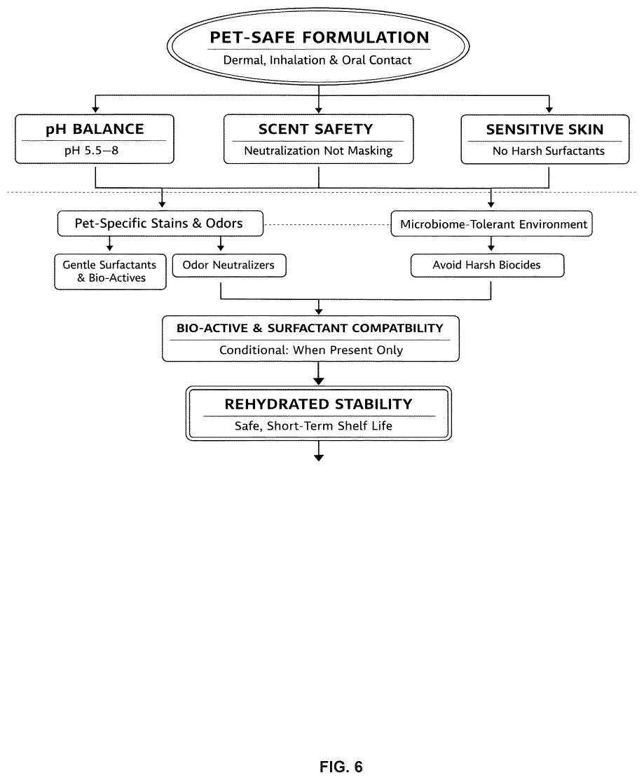

Referring to FIG. 5, a method 500 of preparing a pet-safe cleaning solution is shown. The method 500 begins with a provide unit dose step 502 of providing an anhydrous solid unit dose composition. The anhydrous solid unit dose composition provided during the provide unit dose step 502 comprises a surfactant system, a pH control system, and a carrier as described previously with reference to the surfactant system 202, the pH control system 204, and the carrier 210. The anhydrous solid unit dose composition may further comprise the bio-active system 208, the odor neutralization system 400, the preservation system 212, the chelating agent 214, and the flow aid 216 as described previously.

With continued reference to FIG. 5, a select container step 504 involves selecting a container for reconstitution of the anhydrous solid unit dose composition. The container may be a bottle, a bucket, a washer, or a basin. The spray bottle may be a reusable container with a trigger sprayer attachment configured for mist, spray, or stream dispensing. The bucket may be used for larger volume cleaning applications where the ready-to-use solution 106 is applied by mop, cloth, or immersion. The washer may be a laundry washer where agitation assists dissolution of the anhydrous solid unit dose composition. The basin may be used for pet bathing applications or for soaking items requiring cleaning. The container selected during the select container step 504 acts as a reaction vessel rather than as storage for a pre-mixed liquid product.

An add water step 506 involves adding water to the container selected during the select container step 504. Adding water during the add water step 506 comprises adding water to a spray bottle, a bucket, a washer, or a basin as selected during the select container step 504. The add water step 506 involves adding water in an amount of about 30 mL to about 3,800 mL as described previously. The amount of water added during the add water step 506 determines the final concentration and pH of the ready-to-use solution 106. The water may be tap water at ambient temperature, and the system 100 is configured to function across varying water hardness levels through the chelating agent 214 described previously.

As further shown in FIG. 5, a dissolve step 508 involves dissolving the anhydrous solid unit dose composition in the water over a period of about 1 minute to about 30 minutes. The dissolve step 508 may include a shake-rest-shake protocol for dissolution of the unit dose in the water. The shake-rest-shake protocol involves an initial shaking period to disperse the anhydrous solid unit dose composition in the water, a rest period to allow dissolution to proceed, and a subsequent shaking period to complete dispersion and dissolution. The shake-rest-shake protocol may be performed manually when the container is a spray bottle or may be performed through mechanical agitation when the container is a washer. The dissolution time during the dissolve step 508 varies based on the unit dose format, binder selection, agitation method, and intended use as described previously.

A solution formed step 510 results in the ready-to-use solution 106 having a pH of about 5.0 to about 8.0 within the pet-safe pH envelope 310 described previously. The ready-to-use solution 106 formed during the solution formed step 510 is configured for use in pet environments. The ready-to-use solution 106 may have a pH of about 5.5 to about 6.5 when configured for hard surface and episodic cleaning applications. The ready-to-use solution 106 may have a pH of about 6.0 to about 7.0 when configured for leave-on, oral-adjacent, or skin-contact applications.

A bio-active activation step 512 occurs upon reconstitution with water when the anhydrous solid unit dose composition includes the bio-active system 208. The bio-active system 208 remains stable in the anhydrous solid unit dose composition in a dry anhydrous form and is activated upon reconstitution with water during the bio-active activation step 512. The bio-active activation step 512 initiates enzyme activity, postbiotic function, or other bio-active mechanisms that were dormant in the dry state. The bio-active activation step 512 enables the enzyme 420 to begin catalytic breakdown of the odor-causing soil 422 into the breakdown products 424 as described previously.

An application step 514 involves applying the ready-to-use solution 106 to pet environments. The application step 514 may involve applying the ready-to-use solution 106 to one or more of the hard surface 110, the fabric 112, the air 114, the pet 116, or the litter system 118 as described previously with reference to FIG. 1. The application step 514 may be performed using the dispensing attachment of the container selected during the select container step 504, such as a trigger sprayer for spray bottle applications or direct pouring for bucket applications.

An odor neutralization step 516 occurs through chemical binding, adsorption, and biological breakdown without reliance on fragrance masking. The odor neutralization step 516 utilizes the odor neutralization system 400 described previously with reference to FIG. 4. During the odor neutralization step 516, the β-cyclodextrin 402 captures the volatile odor molecule 404 to form the inclusion complex 406. The zinc ricinoleate 408 binds the amine sulfur compounds 410 to form the bound complex 412. The zeolite 414 adsorbs the ammonia compounds 416 to form the adsorbed compounds 418. The enzyme 420 breaks down the odor-causing soil 422 into the breakdown products 424. The odor neutralization step 516 neutralizes odors through these mechanisms rather than through fragrance masking.

The anhydrous solid unit dose composition may be configured for use in pet environments as described previously. The pet environments include hard surfaces, fabrics, air, direct pet application to skin or coat, oral-adjacent applications, and litter systems. Different product configurations within the system architecture address specific application contexts while maintaining the constrained pH ranges, mild surfactant selection, and non-masking odor neutralization mechanisms described previously.

Hard surface applications include floors, countertops, crates, kennels, feeding areas, and other surfaces in pet environments where cleaning and odor neutralization are considerations. Hard surface configurations may utilize the leave-on extended contact pH range of about 5.5 to about 6.5 to support enzyme activity and preservation system efficacy while minimizing ammonia volatilization from urine-based soils. Hard surface configurations may include higher surfactant loading within the surfactant system for soil removal and may include the odor neutralization system with β-cyclodextrin, zinc ricinoleate, and zeolite for broad-spectrum odor control.

Fabric applications include pet bedding, carpets, upholstery, clothing, and laundry items that contact pets. Fabric configurations may be provided as laundry tablets with higher surfactant loading of about 25 wt % to about 60 wt % of the unit dose and enhanced chelation for hard water robustness. Fabric configurations may include sodium carboxymethyl cellulose as an anti-redeposition agent to prevent removed soils from redepositing onto fabrics during wash cycles. Fabric configurations may include the bio-active system with protease, amylase, lipase, and cellulase for breakdown of protein, starch, fat, and cellulose-based soils on fabrics.

Air applications include room air deodorization and enclosed spaces where pet odors accumulate. Air configurations may utilize low surfactant content to avoid residue on surfaces when the ready-to-use solution is applied as a mist. Air configurations may emphasize β-cyclodextrin for capture of volatile odor molecules while minimizing surfactant content to maintain clarity and prevent clogging in pump spray delivery systems. Air configurations may be provided with dilution volumes and unit dose masses selected to produce very dilute formulation concentrations suitable for air application without leaving visible residue.

The composition may be configured for application to pet skin or pet coat. Direct pet application configurations include shampoos, conditioners, paw cleansers, and topical treatments where the ready-to-use solution contacts pet skin or coat. Direct pet application configurations may utilize the wash-off short contact pH range of about 6.7 to about 7.0 to accommodate skin contact while maintaining compatibility with the preservation system and bio-active system.

Skunk odor removal configurations may utilize higher loadings of zinc ricinoleate for binding sulfur-containing thiol compounds characteristic of skunk spray. Skunk odor removal configurations may be provided within the wash-off short contact pH range for application to pet coat followed by rinsing. Skunk odor removal configurations may include the surfactant system with mild solid surfactants for cleansing while the odor neutralization system addresses the sulfur-based odor chemistry of skunk spray through chemical binding rather than fragrance masking.

Litter box deodorizer configurations may utilize higher adsorbent loading with zeolite for ammonia control in cat litter applications. Litter box deodorizer configurations may include the odor neutralization system with zeolite present at higher loadings within the range of about 1 wt % to about 20 wt % of the unit dose to address ammonia volatilization from cat urine. Litter box deodorizer configurations may be provided as powder formats for direct application to litter or as solutions for cleaning litter box surfaces.

The composition may be configured for paw cleanser applications with wash-off formulation and skin comfort ingredients. Paw cleanser configurations may utilize the wash-off short contact pH range of about 6.7 to about 7.0 for brief contact with paw pads and interdigital skin. Paw cleanser configurations may include the skin comfort system with betaine, allantoin, and aloe powder for soothing properties during and after cleansing. Paw cleanser configurations may include the surfactant system at moderate levels sufficient for soil removal from paws while maintaining mildness for repeated use.

The composition may be configured for itch relief spray applications with skin soothing agents and neutral pH. Itch relief spray configurations may utilize the wash-off short contact pH range of about 6.7 to about 7.0 for skin compatibility during topical application. Itch relief spray configurations may include the skin comfort system with colloidal oatmeal, allantoin, and aloe powder for anti-itch and soothing properties. Itch relief spray configurations may include reduced surfactant levels or may omit surfactants where cleansing is not a primary function and skin soothing is the primary consideration.

The composition may be configured for oral-adjacent pet applications. Oral-adjacent applications include mouth wash sprays and water bowl additives where the ready-to-use solution may contact oral tissues or may be ingested in small amounts. Oral-adjacent configurations may utilize the leave-on oral-adjacent pH range of about 6.0 to about 7.0 for oral tolerance and sensory acceptability.

The composition may be configured for dog mouth wash spray applications with oral-safe pH and plaque control agents. Dog mouth wash spray configurations may include zinc gluconate or similar plaque control agents compatible with the oral-safe pH range. Dog mouth wash spray configurations may include breath freshening agents such as aloe vera extract and citric acid that function within the constrained pH architecture. Dog mouth wash spray configurations may exclude xylitol due to toxicity concerns in dogs and may exclude artificial dyes that are unnecessary for oral care function.

The composition may be configured for water bowl additive applications with oral-safe ingredients at very low concentrations. Water bowl additive configurations may be provided with unit dose masses and dilution volumes selected to produce very low formulation concentrations suitable for addition to drinking water. Water bowl additive configurations may include plaque control agents and breath freshening agents at concentrations safe for repeated ingestion over time. Water bowl additive configurations may utilize the leave-on oral-adjacent pH range to maintain palatability and oral tissue compatibility.

The composition may be configured for pet skin lotion applications as a leave-on formulation with lipid powders and humectants. Pet skin lotion configurations may utilize the leave-on oral-adjacent pH range of about 6.0 to about 7.0 for extended skin contact and potential oral exposure through grooming behavior. Pet skin lotion configurations may include the skin comfort system with MCT oil powder, sunflower lecithin powder, sodium PCA, and panthenol for emollient and humectant properties. Pet skin lotion configurations may include rheology modifiers such as xanthan gum or sclerotium gum for solution viscosity appropriate for lotion application.

The composition may be configured for paws and nose lotion applications with barrier-supporting ingredients. Paws and nose lotion configurations may include the skin comfort system with lipid powders and humectants for barrier support on paw pads and nose leather. Paws and nose lotion configurations may include allantoin and panthenol for skin barrier integrity and healing support. Paws and nose lotion configurations may be provided as leave-on formulations within the leave-on oral-adjacent pH range to accommodate licking behavior common with paw and nose applications.

The composition may be configured for conditioner applications with enhanced conditioning agents and postbiotics. Conditioner configurations may include the bio-active system with postbiotics such as Lactobacillus ferment filtrate, Lactococcus ferment, Leuconostoc ferment, Saccharomyces ferment, and Saccharomyces lysate for skin microbiome support and conditioning benefits. Conditioner configurations may include the skin comfort system with betaine, panthenol, and colloidal oatmeal for coat conditioning and skin comfort. Conditioner configurations may utilize the wash-off short contact pH range for rinse-off application following shampooing.

The composition may be configured for sensitive skin shampoo applications with reduced surfactant levels and enhanced soothing agents. Sensitive skin shampoo configurations may include the surfactant system at reduced levels within the lower portion of the range of about 0.5 wt % to about 60 wt % to minimize potential for irritation on sensitive pet skin. Sensitive skin shampoo configurations may include the skin comfort system with colloidal oatmeal, allantoin, and aloe powder at enhanced levels for soothing properties. Sensitive skin shampoo configurations may utilize the wash-off short contact pH range of about 6.7 to about 7.0 for skin compatibility during bathing.

The composition may be configured for flea and tick spray applications with botanical-based repellent ingredients. Flea and tick spray configurations may include botanical-based repellent ingredients such as lemongrass hydrosol, cedarwood hydrosol, catnip extract, lavender hydrosol, or apple cider vinegar that provide insect repellent function without the toxicity concerns associated with permethrin, pyrethroids, or DEET. Flea and tick spray configurations may exclude neem oil, citronella, tea tree oil, and pennyroyal due to toxicity or irritation concerns in pets. Flea and tick spray configurations may include the skin comfort system with soothing agents for skin compatibility during topical application. Flea and tick spray configurations may utilize the wash-off short contact pH range for topical spray application to pet coat.

The ready-to-use solution has a rehydrated stability of about 1 month to about 12 months. The rehydrated stability refers to the period after reconstitution during which the ready-to-use solution maintains functional efficacy and microbial stability for the intended application. The rehydrated stability range varies based on the product category and intended use context, with different stability targets appropriate for different application types within the system architecture.

The ready-to-use solution may have a rehydrated stability of about 3 months to about 6 months for leave-on, medical-adjacent, and oral-adjacent products. Leave-on products include pet skin lotions, paws and nose lotions, and similar formulations that remain on pet skin or coat after application without rinsing. Medical-adjacent products include skin disinfectant and relief sprays and similar formulations that contact compromised or sensitive skin. Oral-adjacent products include mouth wash sprays and water bowl additives where the ready-to-use solution may contact oral tissues or may be ingested. The shorter rehydrated stability range for these product categories reflects the more stringent preservation requirements associated with extended skin contact, contact with compromised skin barriers, and potential oral exposure.

The ready-to-use solution may have a rehydrated stability of about 6 months to about 12 months for hard surface and episodic cleaners. Hard surface cleaners include stain and odor cleaners, urine cleaners, cat urine cleaners, multi-surface cleaners, and similar formulations applied to floors, countertops, crates, kennels, and other surfaces in pet environments. Episodic cleaners include products used intermittently for specific cleaning tasks rather than daily use. The longer rehydrated stability range for hard surface and episodic cleaners reflects the lower preservation challenge associated with surface application where the ready-to-use solution does not contact skin or oral tissues and where the acidic pH range of about 5.5 to about 6.5 supports preservation system efficacy.

The ready-to-use solution may have a rehydrated stability of about 4 months to about 9 months for skin-contact cleansing and conditioning products. Skin-contact cleansing products include shampoos, paw cleansers, and similar wash-off formulations that contact pet skin during use. Conditioning products include conditioners and similar formulations applied to pet coat and skin. The intermediate rehydrated stability range for skin-contact cleansing and conditioning products reflects the balance between skin contact considerations and the wash-off nature of these applications where contact time is limited compared to leave-on formulations.

Preservation is justified by post-dilution use rather than dry storage. The anhydrous solid unit dose composition is chemically stable in dry form without requiring liquid preservatives, and the preservation system is evaluated based on performance after reconstitution with water at the point of use. The dry state of the anhydrous solid unit dose composition does not support microbial growth, and preservation becomes relevant when water is added during reconstitution to form the ready-to-use solution. The preservation system content and selection are determined by the rehydrated stability target for the intended product category rather than by dry storage requirements.

The preservation system is compatible with the bio-active system at the pH of the ready-to-use solution as described previously. The preservation system comprising gluconolactone, sodium benzoate, potassium sorbate, phenoxyethanol, and ethylhexylglycerin is selected to maintain preservation efficacy within the pH range of about 5.0 to about 8.0 without impairing the function of enzymes, postbiotics, ferments, lysates, or other bio-active components. The preservation system and bio-active system coexist in the ready-to-use solution, with both systems functioning within the buffered pH environment maintained by the pH control system. The rehydrated stability targets are achieved through the combination of preservation system selection, pH control, and formulation architecture that maintains compatibility between preservation and bio-active function throughout the post-dilution storage period.

The following examples illustrate representative formulations within the system architecture described previously. These examples are provided for illustration and do not limit the scope of the compositions, methods, and systems described herein.

Example 1 describes a stain and odor cleaner spray with enzymatic activity. The formulation is configured as a single-dose powder pack of about 8.0 g for reconstitution in about 532 mL of water. The target pH of the ready-to-use solution is about 6.2 to about 6.8, falling within the leave-on extended contact pH range suitable for hard surface and episodic cleaning applications.

The surfactant system of Example 1 comprises sodium cocoyl isethionate at about 6.0 wt % to about 12.0 wt % of the unit dose, sodium lauryl sulfoacetate at about 3.0 wt % to about 8.0 wt % of the unit dose, sodium cocoyl glutamate at about 2.0 wt % to about 6.0 wt % of the unit dose, and sodium cocoamphoacetate at about 3.0 wt % to about 8.0 wt % of the unit dose. The chelating agent comprises tetrasodium glutamate diacetate at about 1.0 wt % to about 3.0 wt % of the unit dose for hard water control.

The pH control system of Example 1 comprises citric acid at about 1.5 wt % to about 3.0 wt % of the unit dose and sodium citrate at about 2.5 wt % to about 6.0 wt % of the unit dose. The citric acid and sodium citrate buffer pair maintains the target pH range while preventing ammonia volatilization from urine-based soils.

The preservation system of Example 1 comprises phenoxyethanol at about 0.50 wt % to about 0.90 wt % of the unit dose and ethylhexylglycerin at about 0.20 wt % to about 0.60 wt % of the unit dose. The preservation system provides rehydrated stability compatible with the neutral pH range of the formulation.

The odor neutralization system of Example 1 comprises β-cyclodextrin at about 0.8 wt % to about 2.5 wt % of the unit dose for odor capture and zinc ricinoleate at about 0.20 wt % to about 0.80 wt % of the unit dose for odor binding. The β-cyclodextrin captures volatile odor molecules through inclusion complex formation, and the zinc ricinoleate binds amine and sulfur odor compounds through chemical complexation.

The enzyme actives of Example 1 comprise protease at about 0.35 wt % to about 1.00 wt % of the unit dose, amylase at about 0.15 wt % to about 0.60 wt % of the unit dose, and lipase at about 0.08 wt % to about 0.40 wt % of the unit dose. The enzymes are provided in granulated form and may serve dual functions of cleaning and odor neutralization. Enzymes such as proteases may break down protein-based organic stains including those from urine, feces, vomit, blood, and saliva. Lipases may break down fat and oil-based stains. Amylases may break down starch-based stains. Many pet-related soils contain both protein components that cause visible staining and organic compounds that cause odor, and enzymatic breakdown of these soils may address both the visible stain component and the odor-causing component simultaneously. The enzymes also reduce odor source over time through substrate breakdown, as the enzymatic degradation of odor-causing organic matter may eliminate the source of the odor rather than merely masking it. The enzymes remain stable in the dry powder and are activated upon reconstitution with water.

Example 1 further comprises silicon dioxide at about 0.4 wt % to about 1.0 wt % of the unit dose as a flow aid and mannitol as a carrier to balance the formulation to 100 wt %. An optional scent placeholder may be included at about 0.00 wt % to about 0.10 wt % of the unit dose in encapsulated form. The dissolution time for Example 1 is about 15 minutes or less with a shake-rest-shake protocol.

Example 2 describes a non-enzymatic stain and odor cleaner spray. The formulation is configured as a single-dose powder pack for reconstitution in about 532 mL of water. The target pH of the ready-to-use solution is about 6.2 to about 6.8. Example 2 relies on surfactant soil removal, cyclodextrin inclusion for volatile odor capture, zinc binding for amine and sulfur odor compounds, and pH control to prevent ammonia volatilization rather than enzymatic degradation of odor-causing soils.

The surfactant system of Example 2 comprises sodium cocoyl isethionate at about 4.0 wt % to about 8.0 wt % of the unit dose, sodium lauryl sulfoacetate at about 2.0 wt % to about 5.0 wt % of the unit dose, sodium cocoyl glutamate at about 2.0 wt % to about 5.0 wt % of the unit dose, and sodium cocoamphoacetate at about 3.0 wt % to about 6.0 wt % of the unit dose.

The odor neutralization system of Example 2 comprises β-cyclodextrin at about 1.0 wt % to about 3.0 wt % of the unit dose for odor capture and zinc ricinoleate at about 0.2 wt % to about 0.8 wt % of the unit dose for odor binding. The chelating agent comprises tetrasodium glutamate diacetate at about 0.2 wt % to about 0.8 wt % of the unit dose.

The pH control system of Example 2 comprises sodium citrate at about 0.4 wt % to about 1.2 wt % of the unit dose and citric acid at about 0.2 wt % to about 0.7 wt % of the unit dose. The preservation system comprises phenoxyethanol at about 0.5 wt % to about 0.9 wt % of the unit dose and ethylhexylglycerin at about 0.2 wt % to about 0.6 wt % of the unit dose.

Example 2 further comprises silicon dioxide at about 0.3 wt % to about 0.9 wt % of the unit dose as a flow aid and mannitol as a carrier to balance the formulation to 100 wt %. An optional scent placeholder may be included at about 0.00 wt % to about 0.15 wt % of the unit dose in encapsulated pet-safe form. Example 2 demonstrates that effective odor neutralization may be achieved without enzymatic activity through the combination of surfactant cleaning, cyclodextrin odor capture, zinc ricinoleate odor binding, and pH control within the constrained pH architecture.

Example 3 describes a pet shampoo powder with postbiotics. The formulation is configured as a dose of about 16.0 g for reconstitution in about 532 mL of water. The target pH of the ready-to-use solution is about 6.7 to about 7.0, falling within the wash-off short contact pH range suitable for shampoo applications. The carrier comprises mannitol, which is non-ionic and skin-safe for grooming applications.

The surfactant system of Example 3 comprises sodium cocoyl isethionate at about 6.0 wt % to about 10.0 wt % of the unit dose, sodium lauryl sulfoacetate at about 4.0 wt % to about 7.0 wt % of the unit dose, sodium cocoyl glutamate at about 3.0 wt % to about 6.0 wt % of the unit dose, and sodium cocoamphoacetate at about 4.0 wt % to about 8.0 wt % of the unit dose.

The chelation and buffer system of Example 3 comprises tetrasodium glutamate diacetate at about 1.0 wt % to about 3.0 wt % of the unit dose, citric acid at about 1.2 wt % to about 2.4 wt % of the unit dose, and sodium citrate at about 4.0 wt % to about 6.2 wt % of the unit dose. Sodium bicarbonate may be included at about 0.0 wt % to about 1.0 wt % of the unit dose as a disintegration base.

The preservation system of Example 3 comprises gluconolactone and sodium benzoate at about 3.0 wt % to about 4.5 wt % of the unit dose and potassium sorbate at about 0.15 wt % to about 0.35 wt % of the unit dose. The gluconolactone and sodium benzoate preservation system provides efficacy at the neutral pH range of the shampoo formulation.

The skin comfort system of Example 3 comprises panthenol at about 0.2 wt % to about 1.0 wt % of the unit dose and allantoin at about 0.10 wt % to about 0.25 wt % of the unit dose. The skin comfort ingredients provide moisturizing and soothing properties for pet skin and coat during bathing.

The postbiotic system of Example 3 comprises Lactobacillus ferment filtrate at about 0.20 wt % to about 1.00 wt % of the unit dose, Lactococcus and Leuconostoc ferment at about 0.05 wt % to about 0.50 wt % of the unit dose, and Saccharomyces ferment or lysate at about 0.05 wt % to about 0.30 wt % of the unit dose. The total postbiotic content is about 0.40 wt % to about 1.50 wt % of the unit dose. The postbiotics are provided in powder form and contribute to skin microbiome support and conditioning benefits for pet skin and coat applications.

Example 3 further comprises silicon dioxide at about 0.3 wt % to about 0.8 wt % of the unit dose as a flow aid and an optional lavender-type fragrance at about 0.05 wt % to about 0.20 wt % of the unit dose in encapsulated form. Mannitol serves as the carrier to balance the formulation to 100 wt %. The dissolution time for Example 3 is about 15 minutes or less.

Example 4 describes a laundry tablet formulation. The formulation is configured as a compressed tablet for use in laundry washers where agitation assists dissolution. The laundry tablet includes surfactants, sodium bicarbonate, chelation and buffering agents, zeolite adsorbent, enzymes, and an anti-redeposition agent.

The surfactant system of Example 4 comprises sodium cocoyl isethionate at about 26 wt % to about 33 wt % of the unit dose, sodium cocoyl glutamate at about 26 wt % to about 33 wt % of the unit dose, and sodium lauryl sulfoacetate at about 16 wt % to about 24 wt % of the unit dose. The higher surfactant loading of Example 4 compared to spray formulations reflects the requirements of laundry cleaning applications.

The chelation and buffer system of Example 4 comprises sodium citrate at about 10 wt % to about 16 wt % of the unit dose and citric acid at about 2.5 wt % to about 5.5 wt % of the unit dose. Tetrasodium glutamate diacetate is present at about 2.5 wt % to about 5 wt % of the unit dose as a chelator for hard water control.

The adsorbent system of Example 4 comprises zeolite at about 2 wt % to about 5 wt % of the unit dose. The zeolite provides adsorbent and builder function, adsorbing ammonia-related compounds from pet-soiled fabrics during the wash cycle.

The odor binding agent of Example 4 comprises zinc ricinoleate at about 0.5 wt % to about 1.2 wt % of the unit dose, provided on a carrier for compatibility with the tablet format.

The enzyme system of Example 4 comprises protease at about 0.20 wt % to about 0.50 wt % of the unit dose, lipase at about 0.15 wt % to about 0.50 wt % of the unit dose, amylase at about 0.15 wt % to about 0.50 wt % of the unit dose, and optionally cellulase at about 0 wt % to about 0.30 wt % of the unit dose. The enzymes are provided in granulated or encapsulated form for stability in the compressed tablet and are activated upon dissolution in the wash water.

The anti-redeposition agent of Example 4 comprises sodium carboxymethyl cellulose at about 0.3 wt % to about 1.2 wt % of the unit dose. The sodium carboxymethyl cellulose is plant-derived and prevents removed soils from redepositing onto fabrics during the wash cycle.

The solid structure system of Example 4 comprises sorbitol at about 3 wt % to about 6 wt % of the unit dose as a binder and dissolution aid, sodium sulfate at about 5 wt % to about 12 wt % of the unit dose as a filler and flow agent, and silicon dioxide at about 0.2 wt % to about 0.8 wt % of the unit dose as a flow and anti-caking agent.

The preservation system of Example 4 comprises sodium benzoate at about 0.2 wt % to about 0.5 wt % of the unit dose for tablet stability and gluconolactone at about 0.1 wt % to about 0.3 wt % of the unit dose as a pH moderation adjunct.

Example 4 excludes sodium hydroxide, sodium metasilicate, optical brighteners, chlorine bleach, TAED activators, quaternary ammonium fabric softeners, synthetic fragrance oils, PEG binders, PVA and PVP tablet films, enzyme-incompatible solvents, and live bacteria. These exclusions maintain compatibility with the pet-safe and enzyme-compatible system architecture.

The formulations of Examples 1 through 4 are configured such that no ingredient exists solely to stabilize another ingredient. Each ingredient within the formulations serves a functional role in the ready-to-use solution, whether for cleaning, odor neutralization, pH control, preservation, skin comfort, or solid processing. The formulation architecture avoids the inclusion of ingredients that function solely as stabilizers for other ingredients, maintaining the principle that each component contributes directly to the performance of the composition in the intended application.

The system architecture described herein allows a single constraint-driven chemical system to support multiple product formats and use cases while maintaining strict biological and chemical boundaries. The constraint-driven chemical system is defined by three interdependent principles: anhydrous solid delivery, water-defined activation at the point of use, and chemically constrained ingredient selection governed by pet safety, odor chemistry, and environmental compatibility. These principles operate together such that modification of one principle affects the others, and the system functions through the simultaneous satisfaction of all three principles rather than through independent optimization of individual components.

The same system architecture may produce sprays, washes, detergents, tablets, and concentrates without reformulating the core chemistry for shelf stability or storage in water. Spray formulations may be configured with unit dose masses and dilution volumes appropriate for trigger sprayer delivery to hard surfaces, fabrics, air, or pet coat. Wash formulations may be configured with unit dose masses and dilution volumes appropriate for bucket or basin applications where larger solution volumes are used for cleaning or bathing. Detergent formulations may be configured with unit dose masses and surfactant loadings appropriate for laundry washer applications where mechanical agitation assists dissolution and soil removal. Tablet formulations may be configured with binder systems and compression parameters appropriate for precise dosing and durability during shipping and handling. Concentrate formulations may be configured with higher active ingredient loadings for dilution into larger volumes or for applications requiring higher solution strength.

The core chemistry of the system remains consistent across these product formats. The surfactant system comprising mild solid surfactants, the pH control system comprising buffering agents, the odor neutralization system comprising non-masking odor removal mechanisms, and the bio-active system comprising enzymes, postbiotics, ferments, lysates, or microbial derivatives may be included in any of the product formats described herein. The selection and loading of these system components may vary based on the intended application, but the underlying chemical architecture and the constraint-driven design principles remain consistent. The system does not require reformulation of the core chemistry to accommodate different product formats because the anhydrous solid delivery format and water-defined activation architecture eliminate the need for liquid stabilizers, emulsifiers, and preservatives that would otherwise require format-specific reformulation.

In some implementations, the compositions of the present disclosure may be configured for airborne odor neutralization and volatile chemical control. Such implementations may include air sprays, room deodorizers, and fabric mists that are applied via spraying or misting into the air or onto fabrics. These airborne applications may present distinct formulation considerations compared to surface cleaning or direct pet contact applications.

In airborne applications, the ready-to-use solution may be atomized or misted, resulting in fine droplets that may be inhaled by humans and pets in the environment. Accordingly, certain ingredients that are acceptable in surface cleaning or wash-off applications may be reduced or excluded in airborne formulations to minimize respiratory exposure risks.

In some implementations configured for airborne application, the composition may be free of surfactants or may comprise a surfactant system at about 0 wt % to about 1 wt % of the unit dose. Surfactants, while useful for soil removal in cleaning applications, may be unnecessary for airborne odor neutralization and may present concerns including film formation on surfaces, foam generation during spraying, and potential respiratory irritation upon inhalation. Air sprays may often be surfactant-free while still achieving effective odor neutralization through the odor capture and odor binding mechanisms described herein.

In some implementations configured for airborne application, the composition may be free of aerosolizable enzymes or other bio-active systems. While enzymes may be effective for breaking down odor-causing soils in cleaning applications, aerosolized enzymes may present respiratory sensitization risks upon repeated inhalation exposure. Accordingly, airborne odor neutralization formulations may rely primarily on chemical capture and binding mechanisms rather than enzymatic breakdown.

The odor neutralization system in airborne formulations may comprise an odor capture agent such as β-cyclodextrin configured to capture volatile odor molecules through inclusion complex formation. The odor neutralization system may further comprise an odor binding agent such as zinc ricinoleate configured to bind amine or sulfur odor compounds. The combination of odor capture and odor binding may provide effective airborne odor neutralization without reliance on fragrance masking, surfactant action, or enzymatic activity.

In some implementations, the airborne formulation may comprise a scent system at about 0 wt % to about 0.5 wt % of the unit dose. The scent system, if present, may be kept intentionally low to avoid olfactory aversion in pets, which have significantly more sensitive olfactory systems than humans. In some cases, the scent system may be encapsulated within the odor capture agent, such as within β-cyclodextrin, to provide controlled release and reduced volatility spikes. The scent system, if present, may not be required for odor neutralization efficacy and may be provided solely for consumer preference.

The pH control system in airborne formulations may comprise a buffering agent such as a citric acid and sodium citrate buffer pair. The ready-to-use solution may have a pH of about 6.0 to about 7.0, which may be compatible with fabric materials and may minimize any potential for respiratory irritation. The pH control system may be present in an amount of about 0.5 wt % to about 10 wt % of the unit dose.

In some implementations, the scent system may comprise one or more pet-safe scents. Pet-safe scents that may be suitable for use in compositions intended for both dogs and cats may include lavender, vanilla, ginger, coconut, and combinations thereof. In some implementations configured for dog-specific products, the scent system may further include additional scents such as Frankincense, Copaiba, Helichrysum, Valerian, and combinations thereof. The selection of scents may be based on the intended species, as cats may have more restrictive scent tolerances than dogs.

In some implementations, the composition may be free of certain scents that may present toxicity concerns for pets. The composition may be free of peppermint, citrus oils including lemon oil, orange oil, and bergamot oil, tea tree oil, pine oil, cinnamon oil, clove oil, oregano oil, thyme oil, or combinations thereof. The exclusion of peppermint may be particularly relevant for flea and tick products, as peppermint is commonly used in conventional flea and tick formulations but may be toxic to cats. In some implementations, cat-safe formulations may have more restrictive scent exclusions than dog-specific formulations. In some implementations, the composition may be free of high-terpene essential oil loads that may cause respiratory irritation or olfactory aversion in pets.

The carrier in airborne formulations may comprise one or more of mannitol, sodium citrate, or sugar alcohols. The carrier may be selected to provide rapid dissolution, solution clarity suitable for spray application, and compatibility with spray mister or atomizer delivery systems.

The composition may further comprise a preservation system to provide rehydrated stability. The preservation system may comprise one or more of gluconolactone, sodium benzoate, and potassium sorbate. The ready-to-use solution may have a rehydrated stability of about 6 months to about 12 months.

The composition may be configured to be reconstituted with about 30 mL to about 500 mL of water. The ready-to-use solution may be configured for delivery via a spray mister or atomizer. The composition may be in the form of a powder, a granule, or a compressed tablet.

Example 5 illustrates an air spray and room deodorizer formulation. The formulation may be configured as a powder for reconstitution in about 192 mL to about 300 mL of water. The target ready-to-use pH may be about 6.5 to about 7.0. The formulation may include β-cyclodextrin at about 3.0 wt % to about 8.0 wt % for odor capture. The formulation may include zinc ricinoleate at about 0.5 wt % to about 2.0 wt % for odor binding, provided on a carrier or in pre-dispersed form. The formulation may include sodium citrate at about 2.0 wt % to about 5.0 wt % and citric acid at about 1.0 wt % to about 3.0 wt % for pH control and as carrier components. The formulation may include gluconolactone and sodium benzoate at about 2.0 wt % to about 4.0 wt % and potassium sorbate at about 0.2 wt % to about 0.5 wt % for preservation. The formulation may optionally include an encapsulated scent at about 0 wt % to about 0.3 wt %. The formulation may include mannitol or sugar alcohols as a carrier to balance to 100 wt %. The formulation may be free of surfactants and free of enzymes.

In some implementations, the compositions of the present disclosure may be configured for surfactant-forward cleaning and organic residue removal without reliance on enzymatic degradation. Such implementations may provide effective soil removal through surfactant action, odor neutralization through chemical capture and binding, and pH control to prevent ammonia volatilization, without requiring enzymes or other bio-active systems.

Surfactant-forward cleaning formulations may be suitable for applications where enzymatic activity is unnecessary, undesired, or where enzyme sensitization is a concern. Some consumers or pets may have sensitivities to enzymes, and surfactant-forward formulations may provide an alternative that achieves effective cleaning through different mechanisms.

In surfactant-forward implementations, the surfactant system may be present in an amount of about 10 wt % to about 35 wt % of the unit dose. The surfactant system may comprise one or more mild solid surfactants selected from the group consisting of sodium cocoyl isethionate, sodium lauryl sulfoacetate, sodium cocoyl glutamate, sodium cocoamphoacetate, and combinations thereof. The surfactant system may provide primary soil removal through emulsification and solubilization of organic residues including oils, greases, and particulate soils.

The odor neutralization system in surfactant-forward formulations may comprise an odor capture agent such as β-cyclodextrin configured to capture volatile odor molecules through inclusion complex formation. The odor neutralization system may further comprise an odor binding agent such as zinc ricinoleate configured to bind amine or sulfur odor compounds. The combination of surfactant soil removal and chemical odor neutralization may provide effective cleaning and deodorizing without enzymatic breakdown of odor-causing substrates.

The pH control system in surfactant-forward formulations may comprise a buffering agent such as a citric acid and sodium citrate buffer pair. The ready-to-use solution may have a pH of about 5.5 to about 6.8. The pH control may serve multiple functions including preventing ammonia volatilization from urine-based soils, maintaining surfactant efficacy, and providing conditions compatible with pet skin and sensitive surfaces.

Surfactant-forward formulations may be free of enzymes or may comprise an enzyme system at about 0 wt % of the unit dose. The absence of enzymes may provide benefits including reduced risk of enzyme sensitization upon repeated exposure, simplified formulation without enzyme stability considerations, and suitability for consumers who prefer non-enzymatic cleaning products.

Example 6 illustrates a surfactant-forward stain and odor cleaner without enzymes. The formulation may be configured as a powder for reconstitution in about 532 mL of water. The target ready-to-use pH may be about 6.2 to about 6.8. The formulation may include sodium cocoyl isethionate at about 4.0 wt % to about 8.0 wt %, sodium lauryl sulfoacetate at about 2.0 wt % to about 5.0 wt %, sodium cocoyl glutamate at about 2.0 wt % to about 5.0 wt %, and sodium cocoamphoacetate at about 3.0 wt % to about 6.0 wt %. The formulation may include β-cyclodextrin at about 1.0 wt % to about 3.0 wt % for odor capture and zinc ricinoleate at about 0.2 wt % to about 0.8 wt % for odor binding. The formulation may include tetrasodium glutamate diacetate at about 0.2 wt % to about 0.8 wt % for hard water control. The formulation may include sodium citrate at about 0.4 wt % to about 1.2 wt % and citric acid at about 0.2 wt % to about 0.7 wt % for pH control. The formulation may include phenoxyethanol at about 0.5 wt % to about 0.9 wt % and ethylhexylglycerin at about 0.2 wt % to about 0.6 wt % for preservation. The formulation may include silicon dioxide at about 0.3 wt % to about 0.9 wt % for processing and mannitol as a carrier to balance to 100 wt %. The formulation may be free of enzymes.

In some implementations, the compositions of the present disclosure may be configured for skin-contact cleansing and conditioning applications including pet shampoos, conditioners, paw cleansers, and related grooming products. Such implementations may be formulated for wash-off application to pet skin and coat, with pH ranges and ingredient selection optimized for skin compatibility and coat conditioning.

Skin-contact cleansing and conditioning formulations may have a ready-to-use pH of about 6.0 to about 7.0, which may be narrower than the pH range for hard surface cleaners. This narrower pH range may support skin barrier integrity, minimize irritation potential, and provide sensory acceptability for both pets and handlers. In some implementations, the ready-to-use pH may be about 6.5 to about 7.0, which may be particularly suitable for sensitive skin applications.

The surfactant system in skin-contact formulations may comprise one or more mild solid surfactants selected from the group consisting of sodium cocoyl isethionate, sodium lauryl sulfoacetate, sodium cocoyl glutamate, sodium cocoamphoacetate, coco glucoside, decyl glucoside, and combinations thereof. The surfactant system may be present in an amount of about 15 wt % to about 40 wt % of the unit dose. The surfactant selection may prioritize mildness and skin compatibility over maximum cleaning power.

Skin-contact formulations may comprise a skin comfort system comprising one or more conditioning or soothing agents. The conditioning or soothing agents may be selected from the group consisting of betaine, panthenol, allantoin, aloe powder, sodium PCA, colloidal oatmeal, glyceryl oleate, and combinations thereof. The skin comfort system may be present in an amount of about 0.5 wt % to about 15 wt % of the unit dose. The skin comfort system may provide benefits including moisturization, soothing of irritated skin, coat conditioning, and improved sensory characteristics of the ready-to-use solution.

In some implementations, skin-contact formulations may further comprise a bio-active system comprising one or more postbiotics. Postbiotics may be preferred over enzymes for skin-contact applications due to their skin-conditioning benefits and compatibility with the skin microbiome. The postbiotics may be selected from the group consisting of Lactobacillus ferment filtrate, Lactococcus ferment, Leuconostoc ferment, Saccharomyces ferment, Saccharomyces lysate, and combinations thereof. The bio-active system may be present in an amount of about 0.05 wt % to about 2 wt % of the unit dose.

In other implementations, skin-contact formulations may be free of bio-active systems including enzymes and postbiotics. Such formulations may rely on surfactant cleansing and conditioning agents for their functional benefits without bio-active components. Formulations without bio-active systems may be suitable for consumers who prefer simpler formulations, for pets with sensitivities to bio-active ingredients, or for applications where bio-active function is unnecessary.

The preservation system in skin-contact formulations may comprise one or more of gluconolactone, sodium benzoate, potassium sorbate, phenoxyethanol, and ethylhexylglycerin. The preservation system may be selected for compatibility with the skin-contact pH range and for mildness on pet skin. The ready-to-use solution may have a rehydrated stability of about 4 months to about 9 months.

Skin-contact formulations may be free of sodium lauryl sulfate, sodium laureth sulfate, silicones, and petroleum-based emollients. These exclusions may provide benefits including reduced irritation potential, improved environmental compatibility, and alignment with consumer preferences for cleaner ingredient profiles.

The composition may be configured to be reconstituted with about 200 mL to about 1,000 mL of water. The unit dose may have a mass of about 8 g to about 30 g. The composition may be in the form of a powder, a granule, or a compressed tablet.

Example 7 illustrates a pet shampoo formulation with postbiotics. The formulation may be configured as a powder of about 16.0 g for reconstitution in about 532 mL of water. The target ready-to-use pH may be about 6.7 to about 7.0. The formulation may include sodium cocoyl isethionate at about 6.0 wt % to about 10.0 wt %, sodium lauryl sulfoacetate at about 4.0 wt % to about 7.0 wt %, sodium cocoyl glutamate at about 3.0 wt % to about 6.0 wt %, and sodium cocoamphoacetate at about 4.0 wt % to about 8.0 wt %. The formulation may include tetrasodium glutamate diacetate at about 1.0 wt % to about 3.0 wt %, citric acid at about 1.2 wt % to about 2.4 wt %, and sodium citrate at about 4.0 wt % to about 6.2 wt %. The formulation may include gluconolactone and sodium benzoate at about 3.0 wt % to about 4.5 wt % and potassium sorbate at about 0.15 wt % to about 0.35 wt % for preservation. The formulation may include panthenol at about 0.2 wt % to about 1.0 wt % and allantoin at about 0.10 wt % to about 0.25 wt % for skin comfort. The formulation may include Lactobacillus ferment filtrate at about 0.20 wt % to about 1.00 wt %, Lactococcus or Leuconostoc ferment at about 0.05 wt % to about 0.50 wt %, and Saccharomyces ferment or lysate at about 0.05 wt % to about 0.30 wt % as postbiotics. The formulation may include silicon dioxide at about 0.3 wt % to about 0.8 wt % and mannitol as a carrier to balance to 100 wt %.

Example 8 illustrates a pet shampoo formulation without postbiotics. The formulation may be configured as a powder of about 14.0 g for reconstitution in about 532 mL of water. The target ready-to-use pH may be about 6.7 to about 7.0. The formulation may include sodium cocoyl isethionate at about 8.0 wt % to about 12.0 wt %, sodium lauryl sulfoacetate at about 5.0 wt % to about 8.0 wt %, sodium cocoyl glutamate at about 4.0 wt % to about 7.0 wt %, and sodium cocoamphoacetate at about 5.0 wt % to about 9.0 wt %. The formulation may include tetrasodium glutamate diacetate at about 1.0 wt % to about 2.5 wt %, citric acid at about 1.0 wt % to about 2.0 wt %, and sodium citrate at about 3.5 wt % to about 5.5 wt %. The formulation may include gluconolactone and sodium benzoate at about 2.5 wt % to about 4.0 wt % and potassium sorbate at about 0.15 wt % to about 0.30 wt % for preservation. The formulation may include betaine at about 1.0 wt % to about 3.0 wt %, panthenol at about 0.3 wt % to about 1.0 wt %, allantoin at about 0.10 wt % to about 0.30 wt %, and colloidal oatmeal at about 0.5 wt % to about 2.0 wt % for skin comfort. The formulation may include silicon dioxide at about 0.3 wt % to about 0.7 wt % and mannitol as a carrier to balance to 100 wt %. The formulation may be free of enzymes and free of postbiotics.

Example 9 illustrates a paw cleanser formulation. The formulation may be configured as a powder of about 6.0 g for reconstitution in about 250 mL of water. The target ready-to-use pH may be about 6.5 to about 7.0. The formulation may include sodium cocoyl isethionate at about 10.0 wt % to about 15.0 wt %, sodium cocoyl glutamate at about 5.0 wt % to about 10.0 wt %, and sodium cocoamphoacetate at about 5.0 wt % to about 10.0 wt %. The formulation may include citric acid at about 1.0 wt % to about 2.5 wt % and sodium citrate at about 3.0 wt % to about 6.0 wt %. The formulation may include gluconolactone and sodium benzoate at about 2.0 wt % to about 3.5 wt % for preservation. The formulation may include aloe powder at about 0.5 wt % to about 2.0 wt % and allantoin at about 0.1 wt % to about 0.3 wt % for skin comfort. The formulation may optionally include zinc ricinoleate at about 0.2 wt % to about 0.6 wt % for odor control. The formulation may include silicon dioxide at about 0.2 wt % to about 0.5 wt % and mannitol as a carrier to balance to 100 wt %.

Different unit doses are configured for different dilution volumes and use contexts. A unit dose configured for spray bottle dilution may have a mass of about 4 g to about 25 g and may be configured for reconstitution in about 192 mL to about 532 mL of water. A unit dose configured for laundry washer use may have a mass of about 8 g to about 30 g and may be configured for reconstitution in larger water volumes determined by the washer fill level. A unit dose configured for bucket or basin use may have a mass selected based on the intended solution volume and concentration for the specific cleaning or bathing application. A unit dose configured for oral-adjacent or medical-adjacent applications may have a mass of about 0.2 g to about several grams and may be configured for reconstitution in smaller water volumes appropriate for the intended use.

No single unit dose is required to span the entire disclosed dilution range of about 30 mL to about 3,800 mL. The system architecture contemplates that different unit doses may be purpose-built for different dilution volumes and use contexts within the disclosed ranges. A unit dose configured for a 192 mL spray bottle application is not required to also function in a 3,800 mL gallon container application. A unit dose configured for a laundry washer application is not required to also function in a dropper or spot-treatment application. The flexibility of the system architecture allows optimization of unit dose mass, active ingredient loading, dissolution characteristics, and physical format for specific applications while maintaining the constraint-driven chemical principles that define the system.

The system architecture supports scaling of formulations without changing the underlying formulation logic. The water-defined activation architecture allows the same chemical system to produce solutions of varying concentration based on the amount of water added during reconstitution. Higher concentrations may be achieved by adding less water to a given unit dose, and lower concentrations may be achieved by adding more water to a given unit dose, within the ranges that maintain the target pH and functional performance of the ready-to-use solution. The scaling flexibility of the system allows a single formulation architecture to address multiple use cases without requiring separate formulation development for each concentration level.

The system architecture maintains strict biological and chemical boundaries across all product formats and use cases. The pH of the ready-to-use solution remains within the pet-safe pH envelope of about 5.0 to about 8.0 regardless of the product format or dilution volume. The exclusion of strong caustic alkalis, chlorine bleach, peroxide bleach, harsh surfactants, volatile organic solvents, and fragrance-based odor masking systems applies across all embodiments of the system. The selection of mild solid surfactants, biodegradable chelators, buffered pH control systems, and non-masking odor neutralization mechanisms applies across all product formats. These boundaries are structural constraints of the system architecture rather than optional preferences that may be modified for specific applications.

### Evaluation and Verification Methods

The following evaluation and verification methods are provided to illustrate representative approaches by which a person having ordinary skill in the art may assess whether an anhydrous solid unit dose composition and a ready-to-use solution formed therefrom fall within the chemical, functional, and performance characteristics described herein. The methods described below are exemplary and non-limiting, and alternative or equivalent analytical, instrumental, sensory, or performance-based evaluation techniques may be employed without departing from the scope of the disclosure.

Unless otherwise indicated, evaluation is performed on the ready-to-use solution after reconstitution of the anhydrous solid unit dose with water at the intended dilution volume. Because the composition is anhydrous prior to use, measurements or evaluations that depend on aqueous conditions are not determinative in the dry state and need not be performed prior to reconstitution.

In some implementations, performance characteristics including cleaning efficacy, odor neutralization, and stability may be evaluated using recognized industry standards or test methods, including but not limited to ASTM, CSMA, ISO, or equivalent protocols, where applicable. In other implementations, qualitative, semi-quantitative, or comparative assessments may be sufficient to confirm functional performance within the intended use context.

### pH Verification After Reconstitution

The pH of the ready-to-use solution may be evaluated after reconstitution of the anhydrous solid unit dose with the intended volume of water. Measurement may be conducted after dissolution equilibrium is reached using a calibrated pH meter, electrode probe, indicator system, or any other pH measurement technique suitable for aqueous solutions.

In some implementations, pH may be evaluated immediately after reconstitution to confirm that the solution falls within the target pH range described herein. In other implementations, pH may be evaluated at one or more later time points during post-rehydration storage to assess pH stability or drift over time. Because the composition is anhydrous prior to use, dry-state pH is not relevant to system performance, and the operative pH for evaluation purposes is the pH of the ready-to-use solution formed upon water activation.

### Cleaning Performance Evaluation

Cleaning performance of the ready-to-use solution may be evaluated using standardized or commonly accepted test methods for assessing soil removal from hard surfaces, fabrics, or other substrates. Such evaluation may include standardized soil removal tests, comparative cleaning assessments, or other procedures routinely employed in the cleaning product industry.

In some implementations, cleaning performance may be assessed relative to a reference formulation, untreated control, or commercially available benchmark product. In other implementations, cleaning performance may be assessed qualitatively or semi-quantitatively based on removal of representative organic soils associated with pet environments, including soils derived from urine, feces, saliva, food residues, or skin secretions.

### Odor Neutralization Assessment (Non-Masking)

Odor neutralization efficacy may be evaluated using analytical methods, sensory methods, or combinations thereof capable of distinguishing reduction of odor-causing compounds from fragrance-based masking effects.

In some implementations, analytical evaluation may include measurement of target volatile odor molecules before and after treatment using headspace analysis, gas chromatography, mass spectrometry, or equivalent techniques. Reduction in the concentration of one or more odor-causing compounds may be indicative of chemical capture, binding, adsorption, or biological degradation mechanisms.

In other implementations, odor neutralization may be evaluated using controlled sensory assessment, including blinded panel evaluation, standardized odor scoring methods, or comparative odor persistence testing. Odor reduction may be assessed immediately after application and over time to distinguish transient masking effects from sustained odor neutralization resulting from removal or transformation of odor-causing compounds.

### Verification of Fragrance Masking Exclusion

Where the composition is described as free of fragrance-based odor masking systems, or where fragrance is present only at minimal levels, verification may include evaluation methods that decouple fragrance perception from odor reduction.

In some implementations, odor reduction may be evaluated after partial or complete dissipation of volatile fragrance components to determine whether odor suppression persists beyond the presence of fragrance. Persistence of odor reduction after fragrance evaporation may indicate chemical capture, binding, adsorption, or biological degradation rather than masking. In other implementations, analytical methods may be used to assess odorant concentration independently of human or animal sensory perception.

### Bio-Active System Compatibility and Activity Retention

When a bio-active system is present, compatibility and functional retention may be evaluated by assessing bio-active performance prior to formulation, after dry storage, and after reconstitution with water.

For enzyme-containing implementations, enzyme activity may be evaluated using substrate-specific assays appropriate to the enzyme class, including protease, amylase, lipase, cellulase, urease, or equivalent enzyme assays. Activity may be expressed as retained activity relative to an initial reference or as comparative activity under defined test conditions. Retained activity is considered sufficient when the bio-active system continues to provide a functional contribution consistent with its intended use, such as measurable odor source degradation, soil breakdown, or other functional effects beyond background or untreated control levels.

For postbiotic, ferment-derived, or microbial derivative systems, functional integrity may be assessed using biochemical markers, activity proxies, or other evaluation methods indicative of retained functional performance following rehydration. Such evaluations may be qualitative or quantitative depending on the nature of the bio-active system.

### Preservative and Bio-Active Interaction Evaluation

Where both a preservation system and a bio-active system are present, compatibility may be evaluated by comparing bio-active performance in the presence and absence of the preservation system at the pH of the ready-to-use solution.

In some implementations, bio-active activity may be assessed immediately after reconstitution and after storage under representative conditions. Preservation efficacy may be evaluated using microbial challenge testing or equivalent methods while monitoring retention of bio-active function. These evaluations may be used to confirm that preservation efficacy and bio-active performance coexist within the disclosed pH and formulation constraints.

### Post-Rehydration Stability Evaluation

Post-rehydration stability of the ready-to-use solution may be evaluated by monitoring one or more functional parameters over time following reconstitution. Such parameters may include pH stability, odor neutralization performance, bio-active activity, microbial control, or combinations thereof.

Stability evaluation may be conducted under ambient storage conditions or accelerated conditions representative of intended consumer use. Retention of functional performance over the intended post-rehydration storage period may indicate acceptable stability for the given application. As used herein, stability refers to the ability of the ready-to-use solution to maintain one or more defined functional characteristics at a level meaningful for the intended post-rehydration use period, rather than merely short-term persistence immediately after mixing.

### Application Context Evaluation Across Use Environments

Suitability of the ready-to-use solution for different application environments may be evaluated using context-appropriate assessment methods.

Hard surface and fabric applications may be evaluated for soil removal, odor reduction, residue formation, or material compatibility. Airborne applications may be evaluated using headspace analysis, dispersion assessment, or equivalent techniques to assess odor reduction without reliance on surface deposition. Skin-contact or oral-adjacent applications may be evaluated through pH verification, ingredient class review, exposure-relevant compatibility assessment, or other methods suitable for assessing tolerance in the intended use context.

These evaluations illustrate the applicability of the disclosed chemical architecture across multiple use environments without requiring identical formulations or identical evaluation protocols for each use case. Different embodiments may include, exclude, or modify individual components based on the requirements of a particular environment, while remaining within the same underlying constraint-driven system architecture defined by water-activated delivery, pH governance, and ingredient compatibility.

The compositions, methods, and systems described herein may be modified in various ways without departing from the scope of the disclosure. The specific ingredients, concentrations, ranges, and parameters described herein are illustrative and may be varied within the disclosed ranges based on the intended application, regulatory context, manufacturing considerations, and desired performance characteristics. Modifications to specific ingredients within a functional system, such as substitution of one mild solid surfactant for another mild solid surfactant within the surfactant system, may be made while maintaining the constraint-driven chemical architecture described herein.

As used herein, the singular forms “a,” “an,” and “the” include plural referents unless the context clearly dictates otherwise. Reference to “a surfactant” includes one surfactant or more than one surfactant. Reference to “an enzyme” includes one enzyme or more than one enzyme. Reference to “the composition” includes one composition or more than one composition within the scope of the disclosure. The use of singular forms throughout the description and claims is for convenience and does not limit the scope of the disclosure to single instances of the described elements.

As used herein, the term “about” when used in connection with a numerical value indicates that the value may vary by plus or minus 10% of the stated value, or by plus or minus 5% of the stated value, or by plus or minus the measurement uncertainty associated with the stated value, unless the context clearly indicates otherwise. The term “about” accommodates variations in manufacturing, measurement, and formulation that may occur in practice while maintaining the functional characteristics described herein.

As used herein, the term “comprising” is open-ended and allows for the inclusion of additional elements, components, or steps beyond those specifically recited. A composition “comprising” a surfactant system and a pH control system may include additional systems, components, or ingredients not specifically recited. The term “comprising” does not exclude the presence of additional elements unless the context clearly indicates otherwise.

The various elements, components, systems, and features described herein may be combined in any combination unless the context clearly indicates that such combination is not possible or is not intended. A composition may include any combination of the surfactant system, pH control system, odor neutralization system, bio-active system, preservation system, chelating agent, flow aid, skin comfort system, and carrier described herein. A method may include any combination of the steps described herein in any order that achieves the functional result of preparing a pet-safe cleaning solution. The disclosure of specific combinations in the examples and embodiments described herein does not exclude other combinations of the disclosed elements.

The ranges disclosed herein include all values and sub-ranges within the stated ranges. A range of about 0.5 wt % to about 60 wt % includes all values between 0.5 wt % and 60 wt %, including 0.5 wt %, 60 wt %, and all intermediate values such as 1 wt %, 5 wt %, 10 wt %, 20 wt %, 30 wt %, 40 wt %, and 50 wt %. A range of about 0.5 wt % to about 60 wt % also includes all sub-ranges within the stated range, such as about 1 wt % to about 30 wt %, about 5 wt % to about 25 wt %, about 8 wt % to about 35 wt %, and about 25 wt % to about 60 wt %. The disclosure of a broad range does not preclude the selection of narrower ranges within the broad range for specific applications or embodiments.

The exclusions described herein define the chemical boundaries of the system architecture. The exclusion of a class of materials, such as strong caustic alkalis or chlorine bleach, applies to all members of that class unless the context clearly indicates otherwise. The exclusion of specific materials, such as sodium lauryl sulfate or methylisothiazolinone, applies to those specific materials and does not necessarily exclude other materials within the same general chemical class that are not specifically excluded. The exclusions described herein are structural constraints that enable the system to function within the pet-safe biological and chemical boundaries described herein.

1. An anhydrous solid unit dose composition for cleaning in pet environments, the composition comprising:
a surfactant system comprising one or more mild solid surfactants;
a pH control system comprising a buffering agent; and
a carrier;
wherein the composition is configured to be reconstituted with water at a point of use to form a ready-to-use solution;
wherein the ready-to-use solution has a pH of about 5.0 to about 8.0; and
wherein the composition is free of strong caustic alkalis, chlorine bleach, and peroxide bleach.

2. The composition of claim 1, wherein the one or more mild solid surfactants are selected from the group consisting of sodium cocoyl isethionate, sodium lauryl sulfoacetate, sodium cocoyl glutamate, sodium cocoamphoacetate, and combinations thereof.

3. The composition of claim 1, wherein the surfactant system is present in an amount of about 0.5 wt % to about 60 wt % of the unit dose.

4. The composition of claim 1, wherein the buffering agent comprises a citric acid and sodium citrate buffer pair.

5. The composition of claim 1, wherein the pH control system is present in an amount of about 0.1 wt % to about 15 wt % of the unit dose.

6. The composition of claim 1, wherein the ready-to-use solution has a pH of about 5.5 to about 6.5.

7. The composition of claim 1, wherein the ready-to-use solution has a pH of about 6.0 to about 7.0.

8. The composition of claim 1, further comprising a chelating agent selected from the group consisting of tetrasodium glutamate diacetate, sodium citrate, and combinations thereof.

9. The composition of claim 1, further comprising a preservation system comprising one or more of gluconolactone, sodium benzoate, potassium sorbate, phenoxyethanol, and ethylhexylglycerin.

10. The composition of claim 1, wherein the composition is in the form of a powder, a granule, or a compressed tablet.

11. The composition of claim 1, wherein the unit dose has a mass of about 0.2 g to about 453 g.

12. The composition of claim 1, wherein the composition is configured to be reconstituted with about 30 mL to about 3,800 mL of water.

13. The composition of claim 1, wherein the composition dissolves in water within about 1 minute to about 30 minutes.

14. The composition of claim 1, wherein the composition is free of sodium lauryl sulfate, sodium laureth sulfate, ammonium lauryl sulfate, linear alkylbenzene sulfonates, alkylphenol ethoxylates, and nonylphenol ethoxylates.

15. The composition of claim 1, wherein the composition is free of volatile organic solvents.

16. The composition of claim 1, wherein the composition is free of microplastics and persistent synthetic polymers.

17. The composition of claim 1, wherein the ready-to-use solution has a rehydrated stability of about 1 month to about 12 months.

18. The composition of claim 1, wherein the carrier comprises one or more of mannitol or sodium sulfate.

19. The composition of claim 1, wherein the composition further comprises a flow aid comprising silicon dioxide.

20. The composition of claim 1, further comprising one or more enzymes selected from the group consisting of protease, amylase, lipase, cellulase, urease, and combinations thereof.

21. The composition of claim 1, further comprising an odor neutralization system comprising one or more of:
an odor capture agent configured to capture volatile odor molecules,
an odor binding agent configured to bind amine or sulfur odor compounds, or
an adsorbent configured to adsorb ammonia-related compounds.

22. The composition of claim 1, further comprising a scent system at about 0 wt % to about 5 wt % of the unit dose.

23.-116. (canceled)
